(19) United States
(12) Patent Application Publication
(10) Pub. No.: US 2005/0198654 A1
(43) Pub. Date: Sep. 8, 2005

(54) Optical disk apparatus

(75) Inventors: Tomotaka Muta, Ogori-shi (JP); Hirohiko Oowaki, Fukuoka-shi (JP); Kenichi Nakano, Fukuoka-shi (JP); Tetsuya Nishio, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 11/071,542

(22) Filed: Mar. 4, 2005

(30) Foreign Application Priority Data
Mar. 5, 2004 (JP) 2004-061981
Mar. 5, 2004 (JP) 2004-061982
Mar. 5, 2004 (JP) 2004-061983
Mar. 5, 2004 (JP) 2004-061984
Mar. 5, 2004 (JP) 2004-061985
May 11, 2004 (JP) 2004-140790
May 11, 2004 (JP) 2004-140791
May 17, 2004 (JP) 2004-146279
May 18, 2004 (JP) 2004-147450
Oct. 14, 2004 (JP) 2004-299889
Oct. 14, 2004 (JP) 2004-299890
Nov. 17, 2004 (JP) 2004-333017

(51) Int. Cl. G11B 17/03

(52) U.S. Cl. 720/601

(57) ABSTRACT

It is an optical disk apparatus which is equipped with a cover, a tray which is disposed in such a manner that it can be inserted into and pulled out from the cover, a spindle motor which is disposed on the tray and rotates an optical disk, and a carriage which is held on the tray in a movable manner and on which an optical device, which carries out at least one of recording and reproduction to an optical disk, is mounted and which comes close to and comes free from the spindle motor and, on a surface of the cover, which faces the carriage, at least one of a concave portion or a convex portion, which is of a nearly circular shape nearly concentrically with a center of the cover or of a polygonal shape nearly concentrically with a center of the cover, is disposed.

### BACKGROUND OF THE INVENTION

1. Field of the Invention

This invention relates to an optical disk apparatus which is suitably used for a stationary type electronic device such as a personal computer, and a portable type electronic device such as a notebook personal computer, a portable type information terminal device, a portable type video device.

2. Description of the related art

FIGS. 76 through 83 are views which show a conventional optical disk apparatus, respectively. In FIGS. 76 through 83, 1 designates a cover, and the cover 1 is composed of an upper cover 1a and a lower cover 1b, and the cover 1 is of a pouch shaped configuration having an aperture 1c at one end portion. A tray 2 is held in the cover in such a manner that it can be inserted into and pulled out from the cover, and the tray 2 is configured by a lightweight material such as a resin material. A bezel 3 is disposed on a front portion of the tray 2, and this bezel 3 is configured so as to close the aperture 1c on the occasion that the tray 2 is put in the cover 1. An eject button 4 appears outside the bezel 3, and by depressing this eject button 4, the cover jumps out of the tray 2 slightly, by a mechanism which is not shown in the figure, and it is possible to make such a situation that it becomes possible to take the tray 2 in and out from the cover 1.

An aperture portion 5 is disposed in the tray 2, and a pickup module 6 is attached to the tray 2 in such a manner that a surface of the pickup module 6 comes out from this aperture portion 5. A spindle motor 7, which drives to rotate an optical disk 9, is disposed on the pickup module 6, and further, a carriage, which comes close to and comes free from the spindle motor, is disposed movably. An optical device, which records information on the optical disk 9 by irradiating the optical disk 9 with light which is not shown in the figure, or carries out reproduction of information by reflected light from the optical disk 9, is mounted on the carriage 8.

10 designates a pickup module which is disposed on the side of the pickup module 6, where the optical disk 9 is loaded, and 11 designates a motor which becomes a drive source for moving the carriage 8, and 12, 13 designate rails which are engaged with both side portions of the tray 2, and further locked to the tray 2, movably in a predetermined area, and 14, 15 designate rail guides which were fixed to the lower cover 1b, respectively, and the rail guides 14, 15 are configured by a resin material, and further, locked by a rail guide fixing portion 16 which is formed integrally with the lower cover 1b. In addition, a locking nail 17 is disposed integrally with the lower cover 1b, and this locking nail 17 contacts a key shaped portion which is disposed on a rear end portion of the rail 12 in such a manner that the rail 12 does not jump out more than a predetermined length. Meanwhile, a portion, which corresponds to the locking nail 17, is disposed integrally with the lower cover 1b, also on the side of the rail 13, but it is not shown in the figure. 18 designates a control substrate which is attached to a rear end portion of the lower cover 1b, and various electronic components such as integrated circuits 19, 20 are mounted on the control substrate 18. In addition, on the occasion that the tray 2 is put in the cover 1, it becomes such a configuration that a part of the control substrate 18 is overlapped with a part of the tray 2.

21 designates a printed board having flexibility, and the printed board 21 electrically connects the control substrate 18 and the tray 2, and various signals for supplying drive electric power of the spindle motor 7 and the carriage 8, transmitting a control signal of the spindle motor 7, the carriage 8, or carrying out control of an optical device which is mounted on the carriage 8 are transferred bi-directionally.

As shown in FIGS. 80, 82 and 83, the spindle motor 7 is composed of a spindle motor frame 70 which is fixed to the pickup module 6, a stator 71 which is fixed to the spindle motor frame 70, and a rotor 72 which is rotatably fixed to the stator 71. The rotor 72 rotates together with an optical disk, holding the optical disk. A holding mechanism, which holds an optical disk, exists within a diameter Φ 15 mm from a rotation center of an optical disk. The holding mechanism may a thing which is equipped with three nail portions made by resin, and may be a thing which absorbs by a magnet.

In addition, in case that a speed of rotation of the optical disk 9 is CD 24× speed, it becomes 5400 rpm at maximum. This speed of rotation becomes approximately 40 km/h at an outermost circumference portion of the optical disk 9 with a diameter Φ 15 mm, converting it into a linear velocity. On this account, when the upper cover 1a and the optical disk 9 are disposed in such a manner that a distance between them becomes approximately 1 mm, there occurs a negative pressure between the optical disk 9 and the upper cover 1a. When stiffness of the upper cover 1a is weak, this negative pressure becomes a sucking force, and there occurs such a phenomenon that the upper cover 1a sinks in. As shown in FIG. 81, there occurs a depression shape whose displacement is maximized at the periphery of the spindle motor 7 which is a rotation center portion of the optical disk 9, and at a position from the rotation center portion to a tray insertion and pullout direction. Next, explanation will be carried out focusing on the periphery of the spindle motor 7 where this large displacement occurs.

FIGS. 82 and 83 are partial side cross-sectional views which show a conventional disk apparatus, respectively, and FIG. 82 shows such a state that the optical disk 9 is rotating, and FIG. 83 shows such a state that the optical disk 9 is rotating, and a negative pressure is generated between the optical disk 9 and the upper cover 1a. When a negative pressure is generated between the optical disk 9 and the upper cover 1a, the periphery of the spindle motor 7 sinks in particularly, and therefore, when a displacement of the upper cover 1 a gets bigger, the rotor 72 upper surface of the spindle motor 7 which rotates the optical disk 9 and the upper cover la, or a name plate which is pasted on the upper cover 1a are in contact with each other. On that occasion, it is conceivable that there occurs a sound due to a contact of the name plate and the rotor 72 of the spindle motor 7, and according to circumstances, a speed of rotation of the optical disk 9 is dropped down.

As prior art, there are (JP-A-2001-307460 publication), (JP-A-2003-151199 publication).

In an optical disk apparatus which is described in the above-described prior art and each patent document, it is always like a thing a weight of which exceeds 140 g.

More weight saving is desired in an electronic device such as a notebook personal computer, and even in an optical disk apparatus, more weight saving is desired along with a request of weight waving of an electronic device.

As described above, there is a necessity to realize more weight saving of an optical disk apparatus whose weight exceeds 140 g, but it is not easy to reduce the number of components easily, in an optical disk apparatus which is effective to various kinds of optical disks. Further, when only materials of the cover 1 which supports each member and of the pickup module 6 which is mounted on the tray 2 are changed to realize weight saving, there is such a possibility that a problem of strength occurs, and only by a simple change of a constituent material of each portion, other characteristics, i.e., recording and reproducing characteristics etc. are deteriorated due to problems of twist and strength of a member.

The invention is a thing which solves the above-described conventional problems, and aims to provide an optical disk apparatus which can realize weight saving.

### SUMMARY OF THE INVENTION

It is an optical disk apparatus which is equipped with a cover, a tray which is disposed in such a manner that it can be inserted into and pulled out from the cover, a spindle motor which is disposed on the tray and rotates an optical disk, and a carriage which is held on the tray in a movable manner and on which an optical device, which carries out at least one of recording and reproduction to an optical disk, is mounted and which comes close to and comes free from the spindle motor and, on a surface of the cover, which faces the carriage, at least one of a concave portion or a convex portion, which is of a nearly circular shape nearly concentrically with a center of the cover or of a polygonal shape nearly concentrically with a center of the cover, is disposed.

According to the optical disk apparatus of the invention, it suppresses deformation of the cover, and significant weight waving becomes possible.

### BRIEF DESCRIPTION OF THE DRAWINGS

FIG. 1 is a perspective view which shows an optical disk apparatus in an embodiment 1 of the invention.

FIG. 2 is a perspective view which shows the optical disk apparatus in the embodiment 1 of the invention.

FIG. 3 is a perspective view which shows the optical disk apparatus in the embodiment 1 of the invention.

FIG. 4 is a perspective view which shows the optical disk apparatus in the embodiment 1 of the invention.

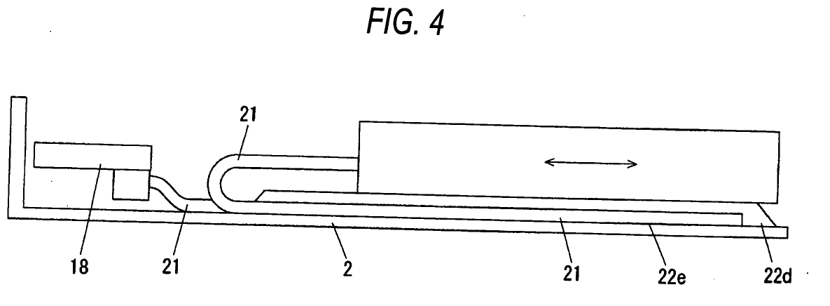

FIG. 5 is a partially enlarged view which shows the optical disk apparatus in the embodiment 1 of the invention.

FIG. 6 is a partially enlarged view which shows the optical disk apparatus in the embodiment 1 of the invention.

FIG. 7 is a partial perspective view which shows the optical disk apparatus in the embodiment 1 of the invention.

FIG. 8 is a partial perspective view which shows the optical disk apparatus in the embodiment 1 of the invention.

FIG. 9 is a partial perspective view which shows the optical disk apparatus in the embodiment 1 of the invention.

FIG. 10 is a partial perspective view which shows the optical disk apparatus in the embodiment 1 of the invention.

FIG. 11 is a partial perspective view which shows the optical disk apparatus in the embodiment 1 of the invention.

FIG. 12 is a partial sectional side view which shows the optical disk apparatus in the embodiment 1 of the invention.

FIG. 13 is a partial perspective view which shows the optical disk apparatus in the embodiment 1 of the invention.

FIG. 14 is a partial sectional side view which shows the optical disk apparatus in the embodiment 1 of the invention.

FIG. 15 is a partial sectional side view which shows the optical disk apparatus in the embodiment 1 of the invention.

FIG. 16 is a partial perspective view which shows the optical disk apparatus in the embodiment 1 of the invention.

FIG. 17 is a partial sectional side view which shows the optical disk apparatus in the embodiment 1 of the invention.

FIG. 18 is a perspective view which shows the optical disk apparatus in the embodiment 1 of the invention.

FIG. 19 is a partial sectional side view which shows the optical disk apparatus in the embodiment 1 of the invention.

FIG. 20 is a partial sectional side view which shows the optical disk apparatus in the embodiment 1 of the invention.

FIG. 21 is a partial sectional side view which shows the optical disk apparatus in the embodiment 1 of the invention.

FIG. 22 is a perspective view which shows an optical disk apparatus in an embodiment 2 of the invention.

FIG. 23 is a front surface view which shows the optical disk apparatus in the embodiment 2 of the invention.

FIG. 24 is a rear surface view which shows the optical disk apparatus in the embodiment 2 of the invention.

FIG. 25 is a partial sectional side view which shows the optical disk apparatus in the embodiment 2 of the invention.

FIG. 26 is a partial sectional side view which shows an optical disk apparatus in an embodiment 3 of the invention.

FIG. 27(a) is a partial sectional side view which shows the optical disk apparatus in the embodiment 3 of the invention, FIG. 27(b) a partial sectional side view which shows the optical disk in the embodiment 3 of the invention.

FIG. 28(a) is a partial sectional side view which shows the optical disk apparatus in the embodiment 3 of the invention, FIG. 28(b) is a partial sectional side view which shows the optical disk in the embodiment 3 of the invention.

FIG. 29 is a partial sectional side view which shows the optical disk apparatus in the embodiment 3 of the invention.

FIG. 30 is a partial sectional side view which shows the optical disk apparatus in the embodiment 3 of the invention.

FIG. 31(a) is a partial sectional side view which shows the optical disk apparatus in the embodiment 3 of the invention, FIG. 31(b) is a partial sectional side view which shows the optical disk in the embodiment 3 of the invention.

FIG. 32 is a partial sectional side view which shows the optical disk apparatus in the embodiment 3 of the invention.

FIG. 33 is a partial sectional side view which shows the optical disk apparatus in the embodiment 3 of the invention.

FIG. 34 is a partial sectional side view which shows the optical disk apparatus in the embodiment 3 of the invention.

FIG. 35 is a partial sectional side view which shows the optical disk apparatus in the embodiment 3 of the invention.

FIG. 36 is a partial perspective view which shows the optical disk apparatus in the embodiment 3 of the invention.

FIG. 37(a) is a perspective view which shows the optical disk apparatus in the embodiment 3 of the invention, FIG. 37(b) is a partial sectional side view which shows the optical disk apparatus in the embodiment 3 of the invention.

FIG. 38 is a perspective view which shows an optical disk apparatus in an embodiment 4 of the invention.

FIG. 39 is a perspective view which shows the optical disk apparatus in the embodiment 4 of the invention.

FIG. 40 is a perspective view which shows the optical disk apparatus in the embodiment 4 of the invention.

FIG. 41 is a perspective view which shows the optical disk apparatus in the embodiment 4 of the invention.

FIG. 42 is a partial perspective view which shows the optical disk apparatus in the embodiment 4 of the invention.

FIG. 43 is a partial perspective view which shows the optical disk apparatus in the embodiment 4 of the invention.

FIG. 44 is a partial perspective view which shows the optical disk apparatus in the embodiment 4 of the invention.

FIG. 45(a) is a partially enlarged view which shows the optical disk apparatus in the embodiment 4 of the invention, FIG. 45(b) is a partial sectional side view which shows the optical disk apparatus in the embodiment 4 of the invention.

FIG. 46(a) is a partially enlarged view which shows the optical disk apparatus in the embodiment 4 of the invention, FIG. 46(b) is a partial sectional side view which shows the optical disk apparatus in the embodiment 4 of the invention.

FIG. 47(a) is a partially enlarged view which shows the optical disk apparatus in the embodiment 4 of the invention, FIG. 47(b) is a partial sectional side view which shows the optical disk apparatus in the embodiment 4 of the invention.

FIG. 48(a) is a partially enlarged view which shows the optical disk apparatus in the embodiment 4 of the invention, FIG. 48(b) is a partial sectional side view which shows the optical disk apparatus in the embodiment 4 of the invention.

FIG. 49(a) is a partial front surface view which shows an optical disk apparatus in an embodiment 5 of the invention, FIG. 49(b) is a partial sectional side view which shows the optical disk apparatus in the embodiment 5 of the invention, FIG. 49(c) is a partial rear surface view which shows the optical disk apparatus in the embodiment 5 of the invention.

FIG. 50(a) is a partial front surface view which shows an optical disk apparatus in an embodiment 5 of the invention, FIG. 50(b) is a partial sectional side view which shows the optical disk apparatus in the embodiment 5 of the invention, FIG. 50(c) is a partial rear surface view which shows the optical disk apparatus in the embodiment 5 of the invention.

FIG. 51(a) is a partial front surface view which shows an optical disk apparatus in an embodiment 5 of the invention, FIG. 51(b) is a partial sectional side view which shows the optical disk apparatus in the embodiment 5 of the invention, FIG. 51(c) is a partial rear surface view which shows the optical disk apparatus in the embodiment 5 of the invention.

FIG. 52(a) is a partial front surface view which shows an optical disk apparatus in an embodiment 5 of the invention, FIG. 52(b) is a partial sectional side view which shows the optical disk apparatus in the embodiment 5 of the invention, FIG. 52(c) is a partial rear surface view which shows the optical disk apparatus in the embodiment 5 of the invention.

FIG. 53(a) is a partial front surface view which shows an optical disk apparatus in an embodiment 5 of the invention, FIG. 53(b) is a partial sectional side view which shows the optical disk apparatus in the embodiment 5 of the invention, FIG. 53(c) is a partial rear surface view which shows the optical disk apparatus in the embodiment 5 of the invention.

FIG. 54(a) is a partial front surface view which shows an optical disk apparatus in an embodiment 5 of the invention, FIG. 54(b) is a partial sectional side view which shows the optical disk apparatus in the embodiment 5 of the invention, FIG. 54(c) is a partial rear surface view which shows the optical disk apparatus in the embodiment 5 of the invention.

FIG. 55(a) is a partial front surface view which shows an optical disk apparatus in an embodiment 5 of the invention, FIG. 55(b) is a partial sectional side view which shows the optical disk apparatus in the embodiment 5 of the invention, FIG. 55(c) a partial rear surface view which shows the optical disk apparatus in the embodiment 5 of the invention.

FIG. 56(a) is a plan view of a frame portion and a coating member, before joining, of an optical disk apparatus in an embodiment 6 of the invention, FIG. 56(b) is an A-A cross-sectional view of the frame portion and the coating member, before joining, of the optical disk apparatus in the embodiment 6 of the invention.

FIG. 57(a) is a joining plan view of the frame portion and the coating member of the optical disk apparatus in the embodiment 6 of the invention, FIG. 57(b) is a B-B cross sectional view of the frame portion and the coating member of the optical disk apparatus in the embodiment 6 of the invention.

FIG. 58(a) is a plan view of the frame portion and the coating member, after joining by an adhesive agent, of the optical disk apparatus in the embodiment 6 of the invention, FIG. 58(b) is a C-C cross sectional view of the frame portion and the coating member, after joining by an adhesive agent, of the optical disk apparatus in the embodiment 6 of the invention, FIG. 58(c) is a plan view of the frame portion and the coating member, after joining by an adhesive agent, of the optical disk apparatus in the embodiment 6 of the invention.

FIG. 59 is a perspective view which shows an optical disk apparatus in an embodiment 7 of the invention.

FIG. 60 is a perspective view which shows the optical disk apparatus in the embodiment 7 of the invention.

FIG. 61(a) to (p) are plan views which show the optical disk apparatus in the embodiment 7 of the invention.

FIG. 62 is a perspective view which shows the optical disk apparatus in the embodiment 7 of the invention.

FIG. 63 is a perspective view which shows an optical disk apparatus in an embodiment 8 of the invention.

FIG. 64 is a cross-sectional view which shows the optical disk apparatus in the embodiment 8 of the invention.

FIG. 65 is a perspective view which shows an optical disk apparatus in an embodiment 9 of the invention.

FIG. 66 is a perspective view which shows an optical disk apparatus in an embodiment 10 of the invention.

FIG. 67 is a partial cross-sectional view which shows an optical disk apparatus in an embodiment 11 of the invention.

FIG. 68 is a partial cross-sectional view which shows an optical disk apparatus in an embodiment 12 of the invention.

FIG. 69 is a perspective view which shows an optical disk apparatus in an embodiment 12 of the invention.

FIG. 70 is a perspective view which shows the optical disk apparatus in the embodiment 12 of the invention.

FIG. 71 is a perspective view which shows the optical disk apparatus in the embodiment 12 of the invention.

FIG. 72 is a perspective view which shows the optical disk apparatus in the embodiment 12 of the invention.

FIG. 73 is a perspective view which shows the optical disk apparatus in the embodiment 12 of the invention.

FIG. 74 is a partial cross-sectional view which shows the optical disk apparatus in the embodiment 12 of the invention.

FIG. 75(a) is a partial front surface view which shows the optical disk apparatus in the embodiment 12 of the invention, FIG. 75(b) is a partial rear surface view in the embodiment 12.

FIG. 76 is a partial perspective view which shows a conventional optical disk apparatus.

FIG. 77 is a partial perspective view which shows the conventional optical disk apparatus.

FIG. 78 is a partial perspective view which shows the conventional optical disk apparatus.

FIG. 79 is a partial perspective view which shows the conventional optical disk apparatus.

FIG. 80(a) is a partial front surface view which shows the conventional optical disk apparatus, FIG. 80(b) is a partial sectional side view which shows the conventional optical disk apparatus, FIG. 80(c) is a partial rear surface view which shows the conventional optical disk apparatus.

FIG. 81 is a view which shows the conventional optical disk apparatus.

FIG. 82 is a partial sectional side view which shows the conventional optical disk apparatus.

FIG. 83 is a partial sectional side view which shows the conventional optical disk apparatus.

### DESCRIPTION OF THE PREFERRED EMBODIMENTS

### Embodiment 1

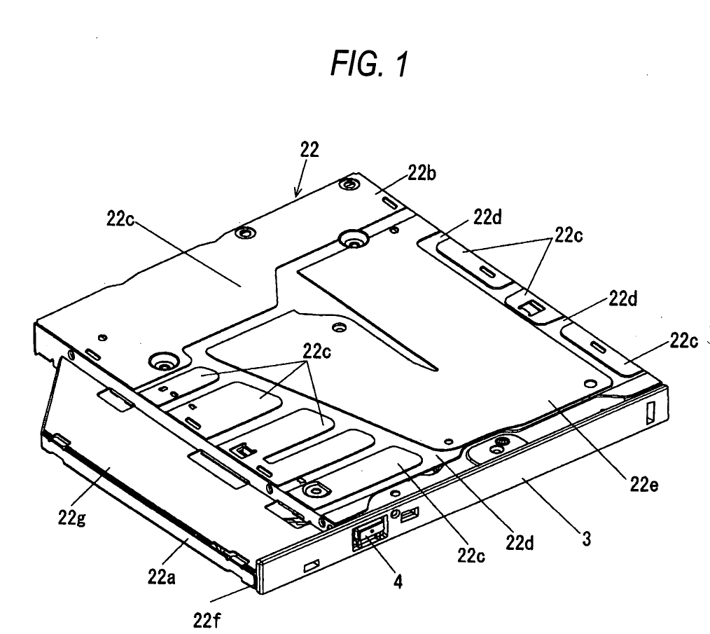

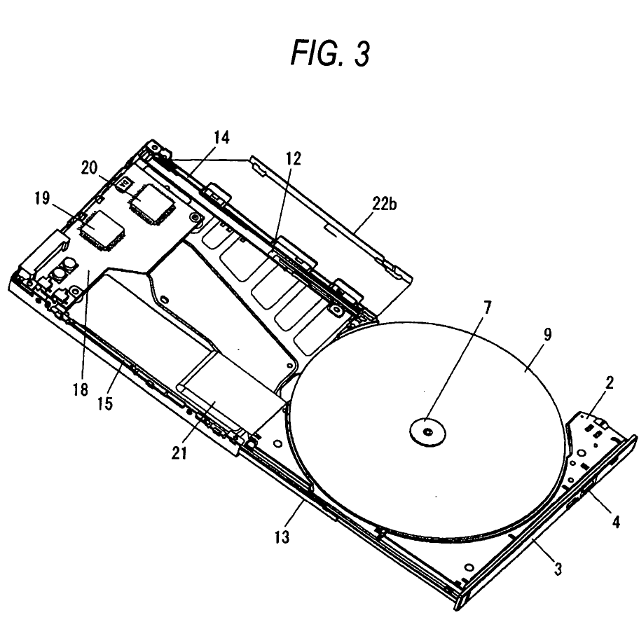

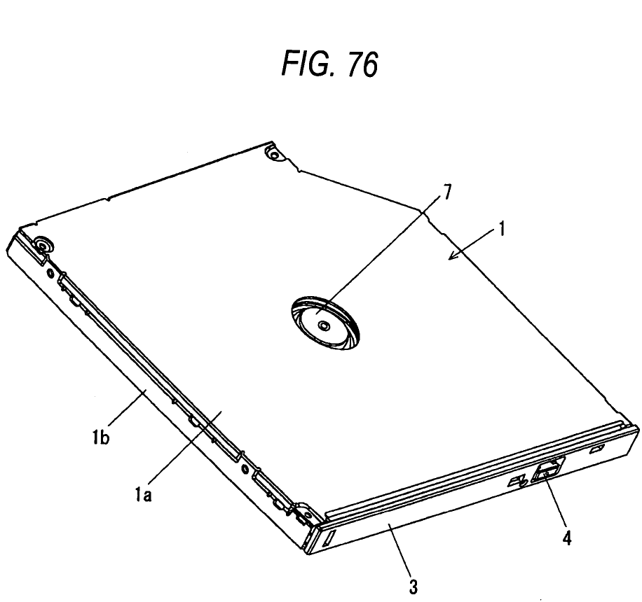

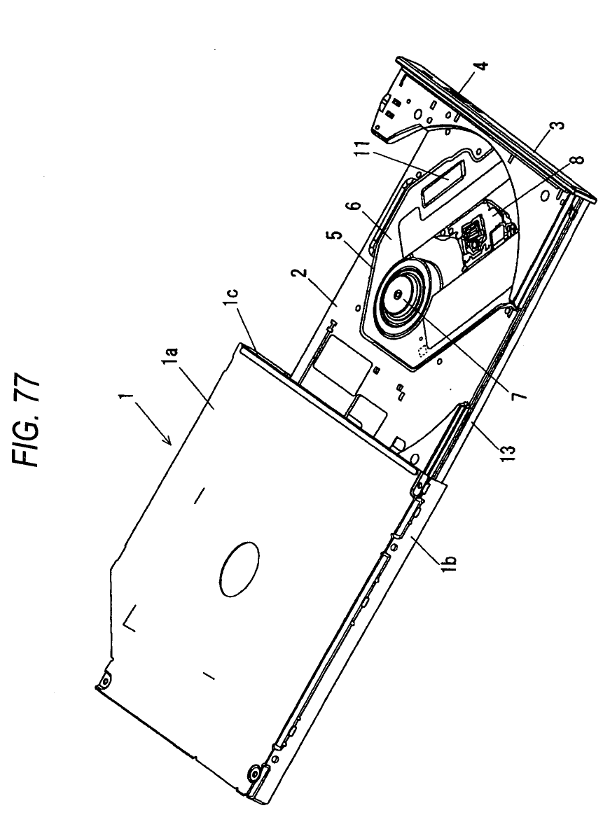

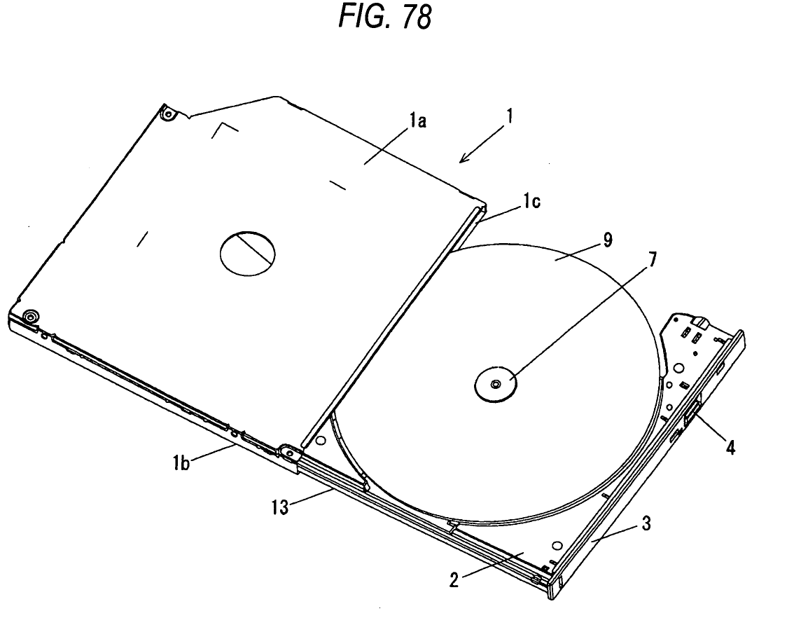

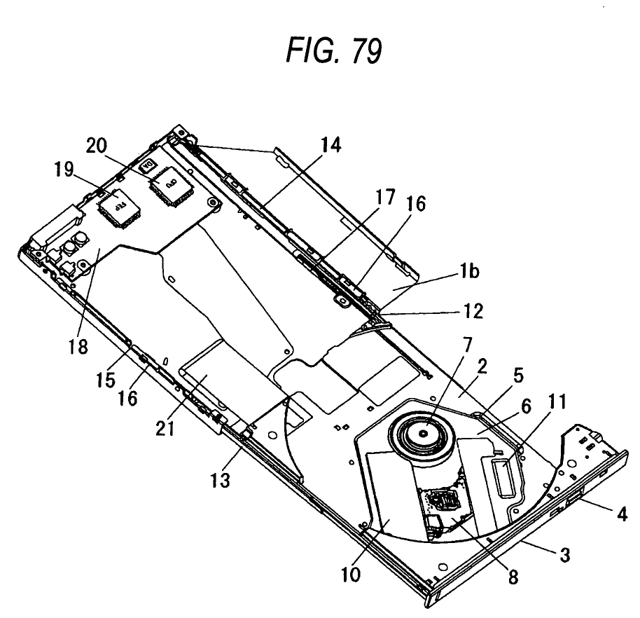

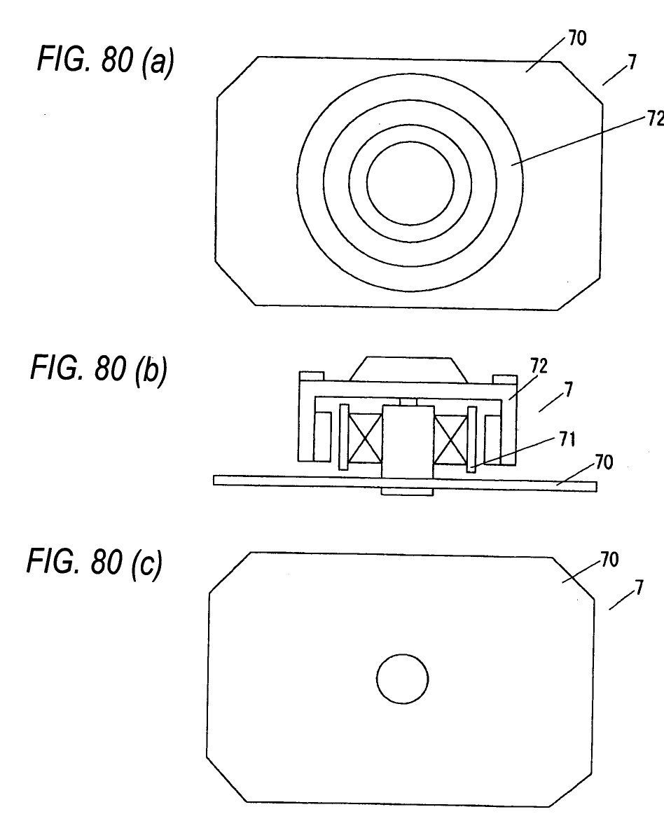

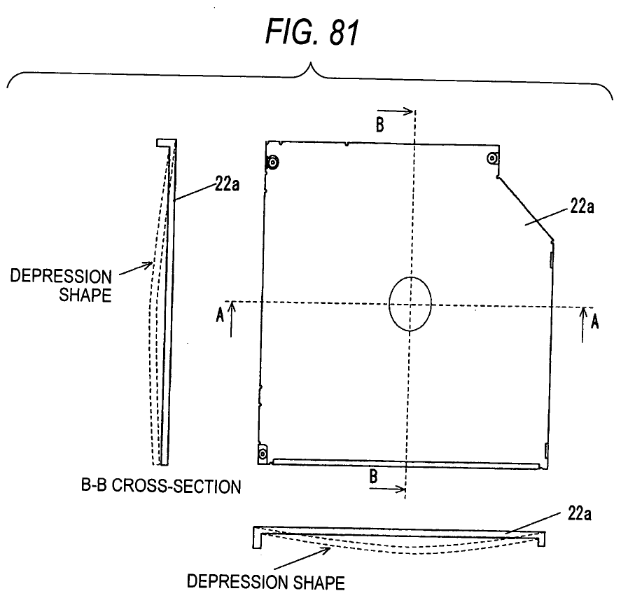

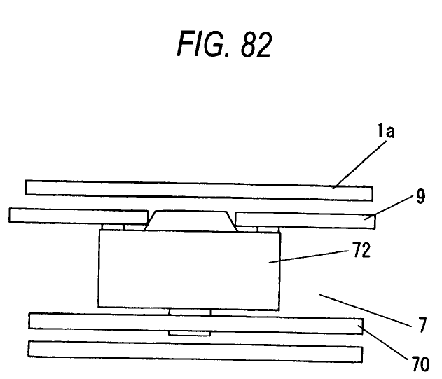

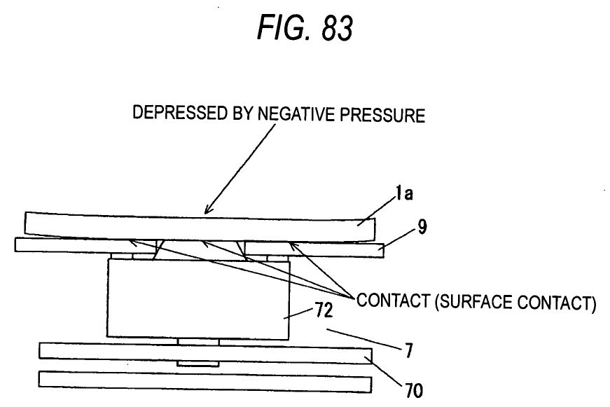

FIGS. 1 through 3 are a perspective view and a plan view which show an optical disk apparatus in an embodiment 1 of the invention, respectively. Meanwhile, the same things as reference numerals and signs shown in FIGS. 76 through 83 are configured by similar shapes, configurations, materials. In FIGS. 1 through 3, 22 designates a cover, and the cover 22 is configured by combining an upper cover 22a and a lower cover 22b by use of at least one of combining means such as an adhesive agent and a locking member. The cover 22 has an aperture 22f, and is configures in a pouch shape. In addition, at least the lower cover 22b (as a matter of course, including a case of both of the upper cover 22a and the lower cover 22b) out of the cover 22 is formed by a plate material or a thin plate material which includes a lightweight metal material, and as the lightweight metal material, aluminum, aluminum alloy, magnesium alloy, titanium, titanium alloy etc. are suitably used, and by processing a plate material which is configured by at least one of those materials, the lower cover 22b is configured. In addition, in the embodiment 1, particularly in consideration of a cost phase and a characteristic phase, aluminum or aluminum alloy is used. In addition, as another embodiment, it is all right even if a multilayer structure is formed by combining plate materials which were configured by the above-described lightweight metal material, each other. For example, it is all right even if the lower cover 22b is configured by combining an aluminum thin plate and an aluminum alloy thin plate, and it is all right even if it is configured by laminating a plurality of an aluminum thin plate and a thin plate which consists primarily of another metal material. In addition, it is all right to use such a compound lightweight plate that a thin plate, which is configured by nickel and nickel alloy, is pasted on both side surfaces of a resin sheet and a resin plate. In addition, it is desirable that at least a thickness of the lower cover 22b is set to 0.15 mm˜0.5 mm, and in case that it is thinner than 0.15 mm, mechanical strength is lowered very much, and there is such a possibility that a trouble occurs, and when it is made thicker than 0.5 mm, it becomes difficult to carry out weight waving.

Meanwhile, in case that it is not particularly explained in subsequent embodiments to this embodiment, they are to be configured by similar shapes, configurations, and materials as those which were described up to this in this embodiment.

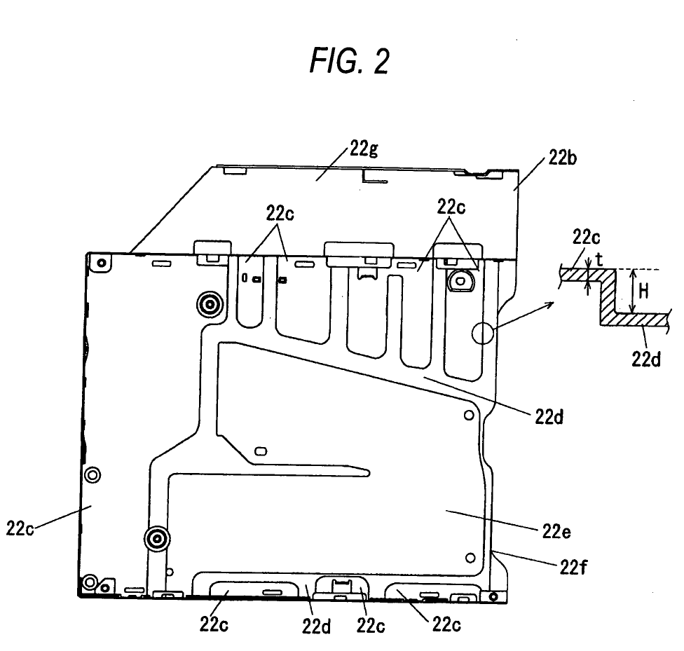

On the lower cover 22b, disposed are convex shaped ribs 22c, 22e which were protruded toward an outside of an apparatus, as shown in FIGS. 1 and 2, and the ribs 22c, 22e become concave shaped ribs 22c, 22e in an inside of the apparatus as shown in FIG. 2. In addition, as shown in FIG. 2, a convex shaped rib 22d, which is protruded in an inside direction in an inside of the apparatus, becomes a concave shaped rib 22d on an outside of the apparatus as shown in FIG. 1. The suchlike concave and convex shaped ribs 22c, 22d and 22e can be easily formed by, for example, applying a press work etc. to the lower cover 22b. Meanwhile, these ribs 22c, 22e are optimally disposed on a portion which is in contact with another member which is disposed outside the optical disk apparatus, and a portion which is attached to another member, and furthermore, it is desirable that the rib 22d is disposed except for a portion which is in contact with or attached to another member.

In addition, in this embodiment, a wing portion 22g, which is located at an end portion of the cover 22 and has a narrower gap than another member, is disposed on the cover 22, and this wing portion 22g is configured by disposing a step at an end portion of the lower cover 22g. Four ribs 22c are disposed on the lower cover 22b toward a center line of the lower cover 22b from this wing portion 22g side, and furthermore, the four ribs 22c are configured so as to become longer gradually as it goes to an aperture 22f. In addition, one rib 22c is disposed at a rear end portion of the lower cover 22b, and further, in a width direction of the lower cover 22b, i.e., in a width direction which is perpendicular direction to such a direction that the tray 2 goes in and out, and optimally, it is disposed so as to get to both end portions which are perpendicular to the width direction of the lower cover 22b. Furthermore, the rib 22c, which is disposed at this rear end portion, is disposed in such a manner that a width of an inserting direction of the optical disk 9 becomes narrower on a side which is opposite to the wing portion 22g side. Further, on the opposite side to the wing portion 22g side, three ribs 22c are disposed. Meanwhile, it is possible to voluntarily select the number and shapes of the ribs 22c, 22d, 22e, and they are arbitrarily selected, depending on a specification and desired strength etc. of the lower cover 22b.

In addition, the rib 22e is disposed between the rib 22c group which is disposed on the wing portion 22g and the rib 22c group which is disposed on an opposite side to the wing portion 22g side, and further, on the aperture portion 22f side of the rib 22c at a rear end portion of the lower cover 22b, and the rib 22e is configured so as to be surrounded by the ribs 22c on three sides, except for the aperture 22f side.

As above, even in case that the lower cover 22b is formed by a plate material which is of relatively low mechanical strength and in addition, is thin, by disposing the ribs 22c, 22d, 22e on the weight saved lower cover 22b, it is possible to improve mechanical strength of the lower cover 22b, and it is possible to obtain mechanical strength of an equivalent level to that of the lower cover 22b which is configured by a conventional thick iron member etc. Therefore, even in case that the rail guides 14, 15 and the control substrate 18 etc. were fixed to the lower cover 22b by screws etc., it is extremely difficult for twist and deformation of the lower cover 22b to occur.

In addition, in this embodiment, it becomes such a configuration that the rib 22e is particularly of a nearly similar shape to a shape of a part of the printed board 21, and in addition, it is possible for the printed board 21 to get into. That is, the rib 22e is formed in a concave shape, in an inside of the lower cover 22b, and by placing a part of the printed board 21 in this rib 22e, it is possible to make a space effectively between the tray 2 and the printed board 21, and it is possible to prevent friction between the printed board 21 and the tray 2, and it is possible to prevent breakage etc. of the printed board 21.

In addition, as shown in FIG. 2, for example, it is better to set up a step H of the rib 22c and the rib 22d so as to satisfy H=(0.2˜4×t, assuming that an average thickness of the lower cover 22b is set to t. When the step H is smaller than 0.2×t, it is difficult to obtain favorable mechanical strength of the lower cover 22b, and when it is larger than 4.0×t, there is such a possibility that a trouble occurs, such as there occurs breakage of the lower cover 22b, or a thin shape could not be realized. In addition, as the thickness t, it is an average thickness of at least 10 places of a thickness of a flat portion of the lower cover 22b.

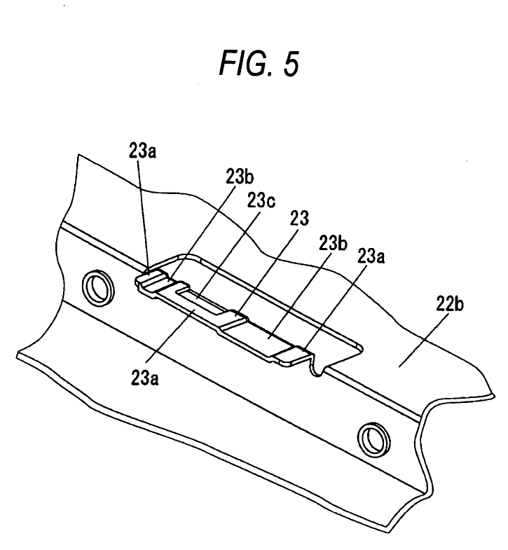

Further, when the lower cover 22b is configured by a material which is relatively thin and lightweight as described above, mechanical strength of each portion is also lowered, and therefore, by disposing concave and convex shaped ribs 23a, 23b also on a rail guide fixing nail 23 which is disposed so as to fix the rail guides 14, 15 to the lower cover 22b, as shown in FIG. 5, it is possible to increase mechanical strength of the rail guide fixing nail 23. That is, in case of such a configuration that the ribs 23a, 23b are not disposed, it is possible to make the rail guide fixing nail 23 hold sufficient stiffness, even if convex portions (not shown in the figure), which were disposed on the rails 12, 13, are inserted into and fixed to a through-hole 23c which is disposed in the rail guide fixing nail 23, and it is possible to surely fix the rail guides 14, 15 to the lower cover 22b, and furthermore, it is possible to prevent dropout etc. of the rail guides 14, 15. Meanwhile, a plurality pieces (2 through 4 pieces) of the rail guide fixing nails 23 are disposed on both sides, respectively, but it is desirable that the ribs 23a, 23b as described above are disposed at least one by one on both sides, among them. Meanwhile, the rail guide fixing nail 23 is disposed integrally with the lower cover 22b, and in addition, the rail guide fixing nail 23 is formed by applying a cutting and turning up work etc. to the lower cover 22b.

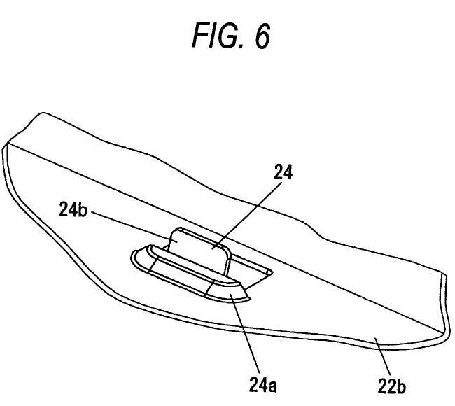

In addition, as shown in FIG. 6, a rail locking nail 24, which is locked with key shaped portions of the rails 12, 13 at their rear end portions, is disposed integrally with the lower cover 22b, in such a manner that the rails 12, 13 do not jump out more than a predetermined length, and in addition, the rail locking nail 24 is formed by applying a cutting and turning up work etc. to the lower cover 22b. It becomes such a configuration that a squeezed portion 24a having a step with predetermined inclination by applying a squeezing work etc. to a root portion of the rail locking nail 24, and a locking portion 24b with a narrower width of that of the squeezed portion 24b, were disposed integrally. By the suchlike configuration, even if the lower cover 22b is configured by a thin and lightweight material, the squeezing work is applied to the root portion of the rail locking nail 24, and in addition, the squeezed portion 24a has a step having inclination, and therefore, it is possible to heighten mechanical strength and stiffness of the rail locking nail 24.

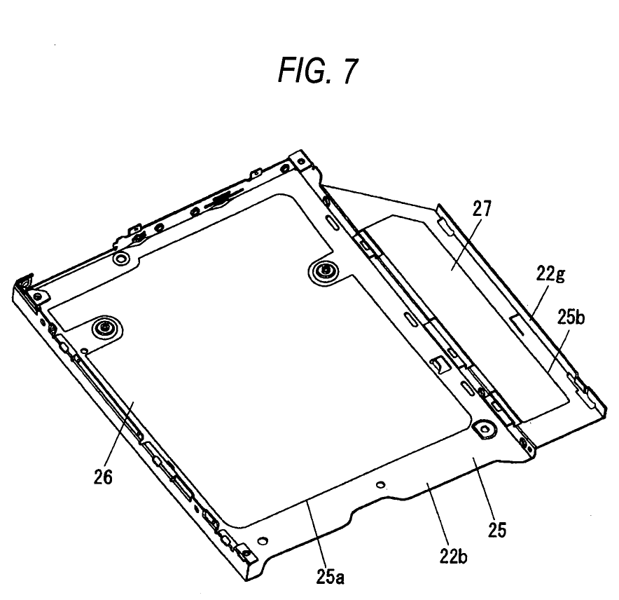

In addition, in the above-described embodiment 1, by disposing the concave and convex shaped ribs 22c, 22d and 22e on the lower cover 22b itself, stiffness and strength etc. of the lower cover 22b is heightened, but it is all right even if a configuration as shown in FIG. 7 is realized.

That is, as shown in FIG. 7, the lower cover 22b is configured by at least two plate materials. Explaining concretely, a frame portion 25a is disposed on the lower cover 22b, and through-holes 25a, 25b of relatively wide areas are disposed so as to close these through-holes 25a, 25b, and the frame portion 25 and coating members 26, 27 are joined with each other. The through-hole 25a is disposed in a main surface portion of the lower cover 22b, and the through-hole 25b is disposed in the wing portion 22g of the lower cover 22b. By using a relatively lightweight plate material etc. as the coating members 26, 27, it is possible to carry out weight saving of the lower cover 22b, and in addition, by configuring the frame portion 25 through the use of a material which is of relatively strong strength and high stiffness, it is possible to improve mechanical strength. That is, it is possible to configure the lower cover 22b which is lightweight and of large mechanical strength. For example, the frame portion 25 is configured by aluminum, aluminum alloy, iron, iron alloy, titanium, titanium alloy etc. which are of relatively large strength, and magnesium alloy, which is relatively lightweight, is used as the coating members 26, 27, and thereby, it is possible to obtain the lightweight lower cover 22b without dropping entire strength. In addition, it is desirable that the through-holes 25a, 25b are disposed individually, but not continuously. That is, if the through-holes 25a, 25b are disposed continuously, a through-hole is to be also disposed in a portion which is disposed between the wing portion 22g and the main surface portion and to which a bending work is applied along a thickness direction, and there is such a possibility that the entire frame portion 25 becomes weak against twist etc. In addition, the frame portion 25 and the coating members 26, 27 are configured by an identical material, and thickness of the coating members 26, 27 is formed so as to be thinner than a thickness of the frame member 25, and thereby, it is also possible to carry out weight saving all the same. In this case, since the coating members 26, 27 and the frame portion 25 are configured by a material of the same kind, it becomes easy to carry out mutual joining. In addition, it is also all right even if the coating members 26, 27 are configured by different lightweight materials, respectively. That is, since the coating member 26 is disposed on a portion to which each member is joined, there is need to relatively heighten stiffness, and the coating member 26 is configured by a plate material which is of relatively large stiffness and strength, and it is possible to select a material which aimed weight saving, for the coating member 27.

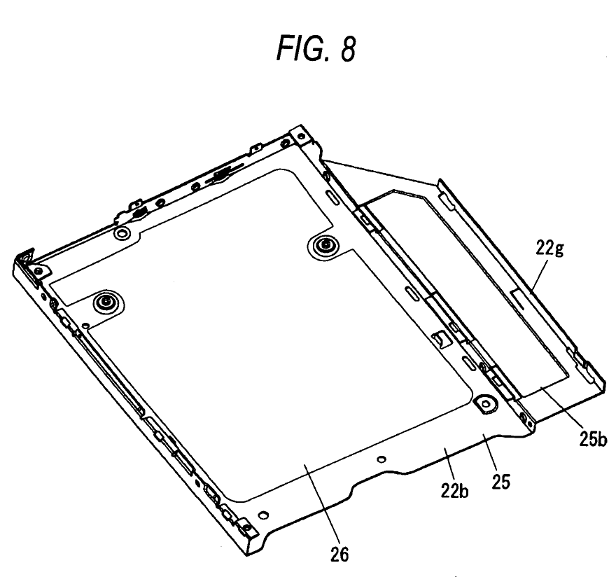

In addition, as shown in FIG. 8, it is also all right even if the coating member 26 is disposed at the through-hole 25a which is disposed in a main surface portion of the lower cover 22b and the coating member 27 is not disposed at the through-hole 25b which is disposed in the wing portion 22g. That is, it has become such a configuration that a part of an optical disk can be seen from a rear surface side of the wing portion 22g of the apparatus. By the suchlike configuration, the coating member 26 is disposed on a main surface portion for which strength and stiffness are relatively required in the same manner as the foregoing, and thereby, it is possible to increase strength and stiffness on a main surface portion to which a large number of members are attached, and in addition, it is possible to realize much further weight waving, since the through-hole 25b is simply disposed in the wing portion 22g.

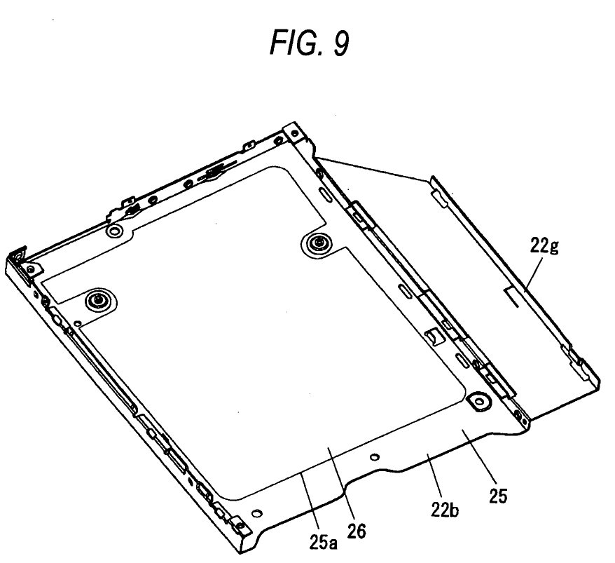

In addition, as shown in FIG. 9, it is all right even if the through-hole 25b is not disposed in the wing portion 22g, and the through-hole 24a is simply disposed in the wing portion 22g, and the coating member 26 is disposed at the through-hole 25a.

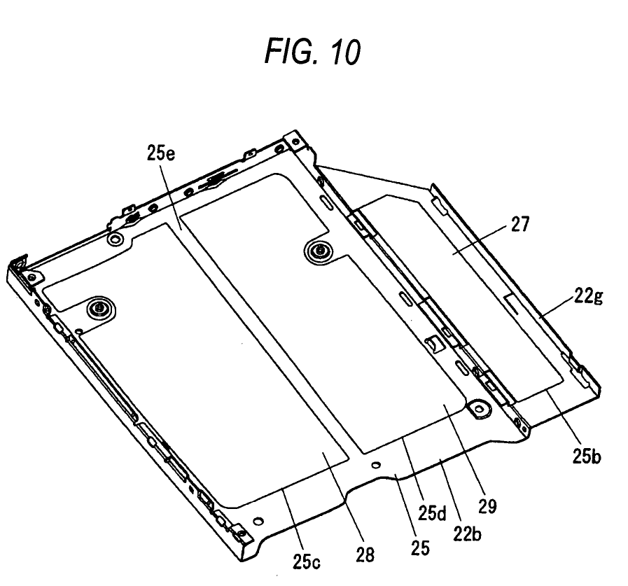

Further, as shown in FIG. 10, the through-holes 25c, 25d are disposed in a main surface portion of the lower cover 22b discontinuously and individually, respectively. By the suchlike configuration, a coupling portion 25e, which is a part of the frame portion 25, is disposed between the through-holes 25c, 25d, and thereby, it is possible to improve stiffness and mechanical strength on the main surface portion. In this way, as a part of the frame portion 25 which is of relatively high strength and stiffness, the coupling portion 25e is disposed along an insertion and pullout direction of the optical disk 9, and thereby, it is possible to improve strength of the main surface portion. Meanwhile, it is all right even if the coupling portion 25e is disposed in a direction which is nearly perpendicular to the insertion and pullout direction.

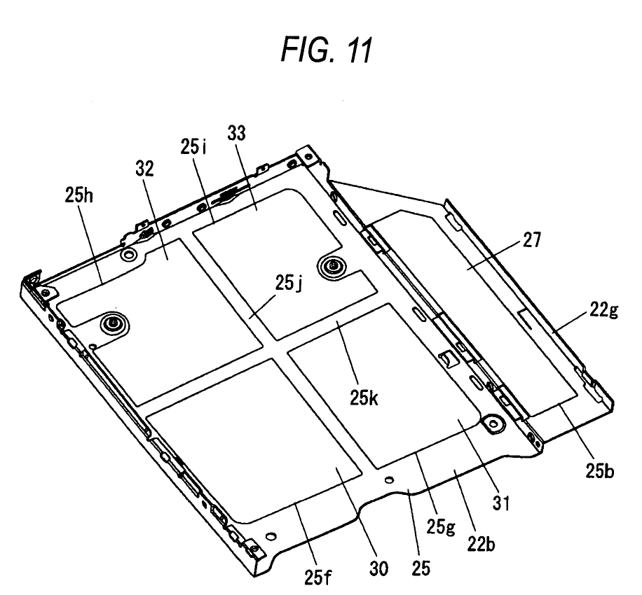

In addition, as shown in FIG. 11, it is also all right even if it is configured in such a manner that through-holes 25f through 25i are disposed in a main surface portion of the lower cover 22b discontinuously and independently, respectively, and coating members 30 through 33, which cover the through-holes 25f through 25i, are attached thereto. By the suchlike configuration, coupling portions 25j, 25k, which are a part of the frame portion 25, are disposed in a cross shape between respective through-holes, and thereby, it is possible to improve stiffness and mechanical strength in the main surface portion. In this way, by disposing the coupling portions 25j, 25k in a cross shape as a part of the frame portion 25 which is of relatively high strength and stiffness, it is possible to more improve strength and stiffness of the main surface portion.

Meanwhile, it is desirable that an area where the above-described each coating member is disposed to a project area of the lower cover 22b is set to 0.2˜0.85. That is, in case that the project area of the lower cover 22b is 1, when a forming area of the above-described each coating member is smaller than 0.2, weight saving makes little headway, and when it exceeds 0.85, a portion where the frame portion 25 exists becomes too much smaller, and there is such a possibility that strength against twist etc. becomes weak.

In the embodiment which is configured as above, it is possible to carry out weight saving partially, with keeping mechanical strength of the lower cover 22 to some extent.

Next, a joining method of the frame portion and the coating member which were described in the above-described embodiment will be described by taking several examples.

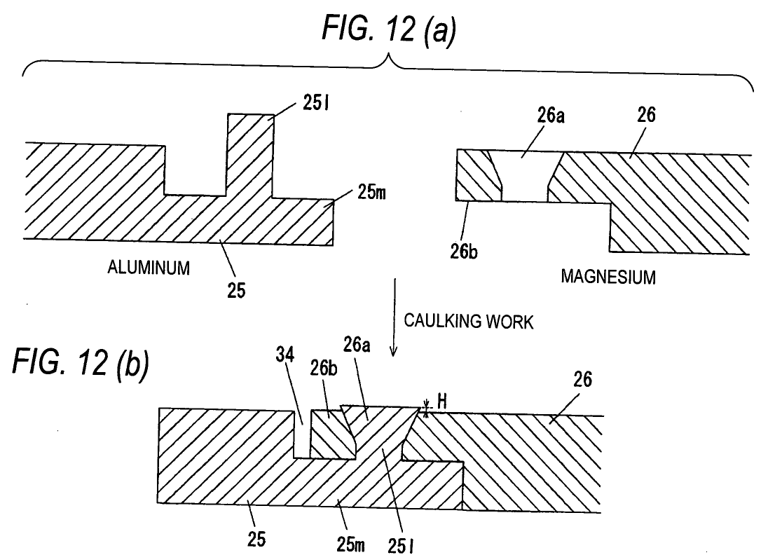

As shown in FIG. 12(a), a plurality of step-dropping down portions 26b are disposed at a peripheral border portion of the coating member 26, or across an entire circumference, and a plurality of through-holes 26a are disposed in this step-dropping down portion 26b, and in this through-hole 26a, a large diameter portion whose diameter becomes small gradually, and a small diameter portion which is coupled to the large diameter portion and has a constant diameter, are disposed, in this embodiment. Further, in this embodiment, it is configured in such a manner that a thickness of the step-dropping down portion 26b becomes approximately a half of a thickness of a plate material which configures the coating member 26.

In addition, a plurality of step-dropping down portions 25m are also disposed at a peripheral border portion of the frame portion 25, or across an entire circumference, and a plurality of protruding portions 25l are disposed on this step-dropping down portion 25m. It is configured in such a manner that the protruding portion 25l becomes a circular cylinder shape having a constant diameter, and in addition, an apex portion becomes slightly higher than a depression depth of the step-dropping down portion 25m. In addition, in this embodiment, it is configured in such a manner that a thickness of the step-dropping down portion 25m becomes approximately a half of a thickness of a plate material which configures the frame portion 25.

In addition, it is desirable that a width of the step-dropping down portions 25m and 26b is 0.8 mm˜1.2 mm. When it becomes more than 1.2 mm, distortion of a member becomes large in case that a step-dropping down process is carried out through the use of press forming. When it becomes less than 0.8 mm, it becomes possible to form the protruding portion 25l.

As shown in FIG. 12(b), the protruding portion 251 is inserted into the through-hole 26a, and a caulking process is applied thereto by use of press etc., and thereby, a cracked portion of the protruding portion 251 is put in a large diameter portion of the through-hole 26a, and the frame portion 25 and the coating member 26 are fixed solidly. Meanwhile, at this time, a dimension of a width on the occasion of disposing the step-dropping down portions 25m, 26b is set to a predetermined relation, and thereby, it is possible to dispose a gap 34, and it is possible to alleviate distortion etc. due to the caulking process by this gap 34. Meanwhile, there is no need to dispose this gap 34 depending on specifications.

In addition, it is functionally desirable that deviation from flatness after joining is 0.1 mm or less, and concavity/convexity H (FIG. 12) of a caulking portion is 0.05 mm or less. When deviation from flatness is more than 0.1 mm, or H is more than 0.05 mm, a clearance of the tray disappears, and it becomes an obstacle at the time that a printed board having flexibility is bent.

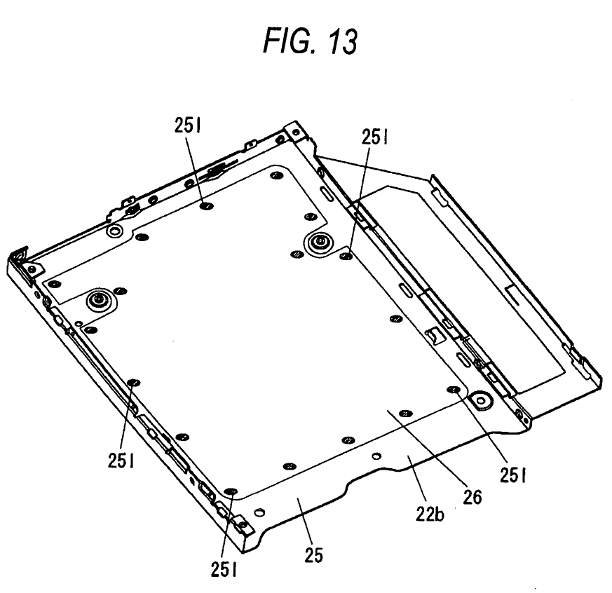

In addition, the lower cover 22b on the occasion of adopting the above-described caulking method is shown in FIG. 13. As shown in FIG. 13, the caulking process is applied at a specific interval, and the coating member 26 and the frame portion 25 were fixed solidly, but it is also all right even if it is disposed at least at one location on each side, or at four locations at a corner portion of the coating member 26.

Meanwhile, in this embodiment, the protruding portion 251 is disposed on the frame portion 25, and the through-hole 26a is disposed in the coating member 26, but it is also all right even if it is configured in such a manner that a through-hole is disposed in the frame portion 25, and a protruding portion is disposed on the coating member 26.

In addition, in this embodiment, a thickness of the step-dropping down portions 25m, 26b is set to be approximately a half of that of a plate material which configures them, respectively, but in case that there is no problem even if a step is generated in some degree at a joining portion of the frame portion 25 and the coating member 26, there is particularly no need to set a thickness of the step-dropping down portions 25m, 26b to a thickness which is a half of that of a plate material.

It is desirable that thickness allocation is carried out in such a manner that strengths of the step-dropping down portions become equal respectively, in tune with material strength of a member to be used. It is desirable that joining strength of a joining portion is a proof strength value or more of each member, in short, the joining portion is not separated before permanent stress is generated on each member.

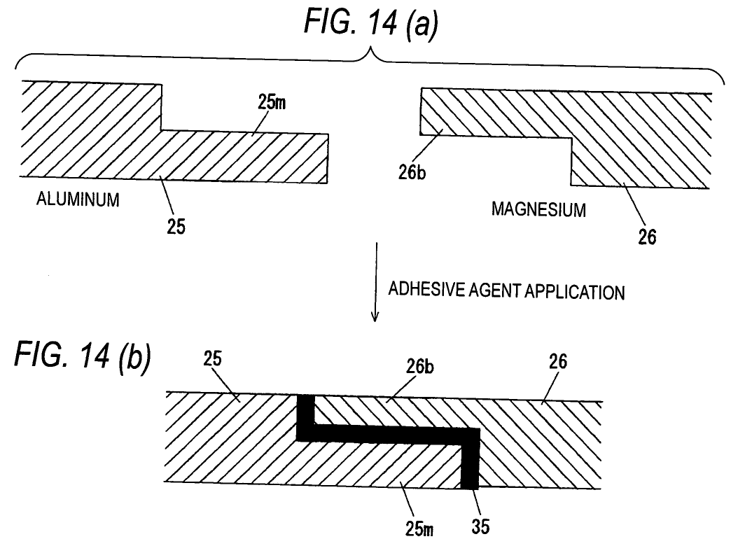

Further, as another joining method, as shown in FIG. 14, it is all right even if an adhesive agent 25 is interposed between the step-dropping down portions 25m, 26a, to join the frame portion 25 and the coating member 26. As the adhesive agent 35, UV curable type, anaerobic curable type, heat curable type, water-absorption type etc. are used desirably. Meanwhile, in this embodiment, the step-dropping down portions 25m and 26a were disposed on entire circumferences of peripheral border portions of the frame portion 25 and the coating member 26, respectively. As to a thickness of the step-dropping down portions 25m and 26a, it is desirable that thickness allocation is carried out in such a manner that strengths of the step-dropping down portions become equal, respectively, in tune with material strength of a member. In addition, it is desirable that a width is 0.8 mm˜1.2 mm. When it becomes more than 1.2 mm, in case that a step-dropping down process is carried out by press forming, distortion of a member becomes larger. When it becomes less than 0.8 mm, an adhesion area goes down, and adhesion strength runs short. In addition, it is all right even if, in order to obtain an electric contact between the coating member 26 and the frame portion 25, electric conductive particles and fiber shaped bodies etc. are mixed in the adhesive agent 35, or a convex portion is disposed on at least one of the step-dropping down portions 25m, 26a, and an electric contact is carried out through the convex portion. Alternatively, it is also all right even if a member such as an electric conductive sheet and rod stock is interposed in a part of a facing portion of the step-dropping down portions 25m, 26a to have them joined by the adhesive agent 35.

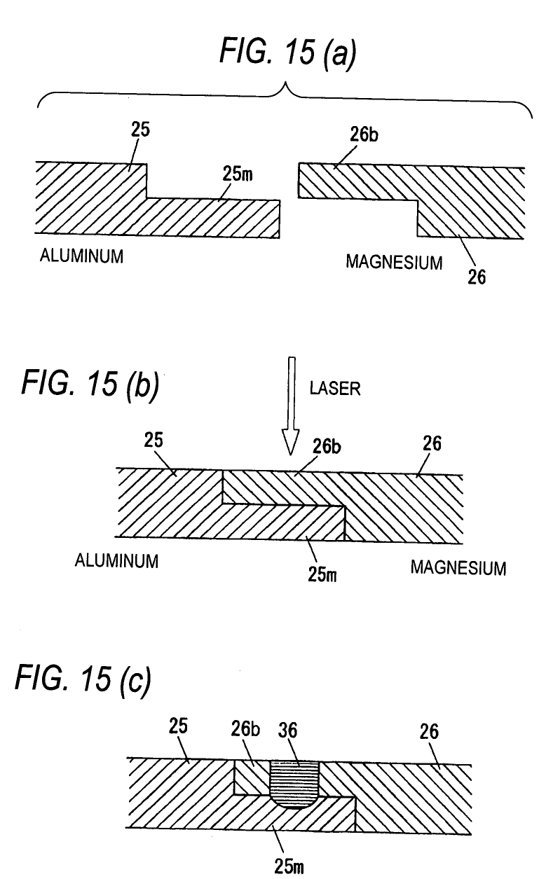

Further, as shown in FIG. 15, after the step-dropping down portions 25m, 26b were made to face with each other without disposing the adhesive agent 35, a portion of both of the step-dropping down portions 25m, 26a is melted by laser welding and resistance welding etc., to form a welded portion 36, and they are fixed each other. Meanwhile, in this embodiment, laser is irradiated from the step-dropping down portion 26b side, but it may be irradiated from the step-dropping down portion 25m side. In this way, the frame portion 25 and the coating member 26 are joined by use of the laser welding and the resistance welding, and thereby, an adhesive agent etc. are unnecessary, and in addition, there is no need to dispose the protruding portion 251 and the through-hole 23c, and therefore, it is possible to improve productivity etc.

Next, the upper cover 22a will be described.

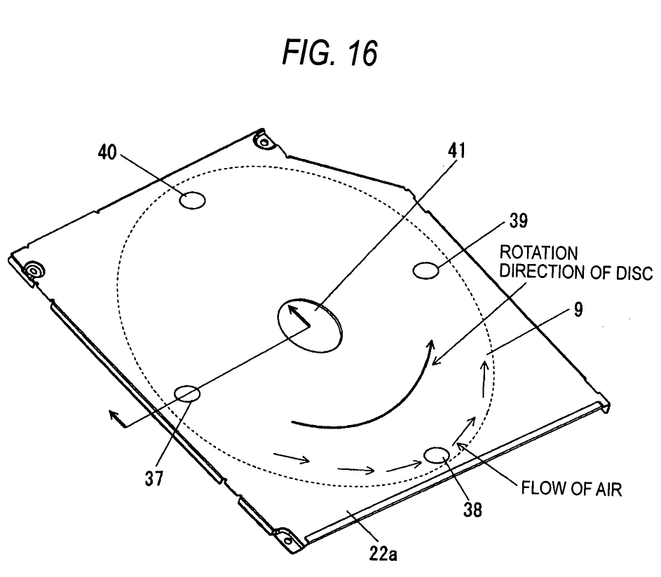

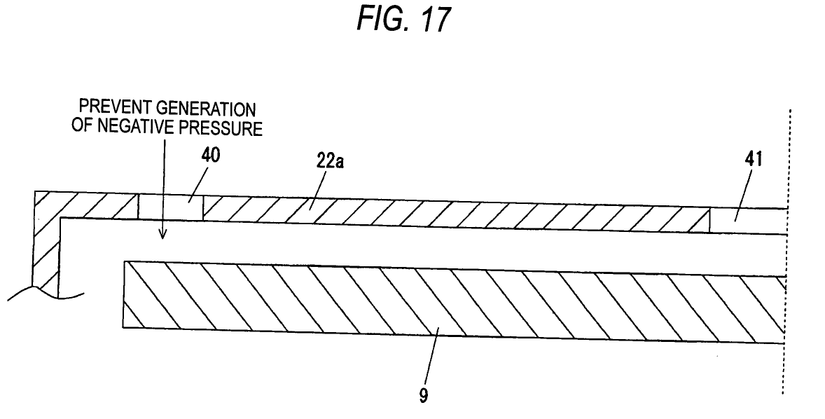

The upper cover 22a is configured by a plat member or a thin plate material which includes a lightweight metal material, in the same manner as the lower cover 22b, and as the lightweight metal material, aluminum, aluminum alloy, magnesium alloy, titanium, titanium alloy etc. are desirably used, and it is configured by processing a plate material which is configured by at least one of those materials. In addition, for the purpose of weight saving, a radial thickness of the upper cover 22a becomes thin, and mechanical strength is relatively lowered. In order to solve this, as shown in FIGS. 16, 17, it is configured in such a manner that through-holes 37 through 40 were disposed in a portion of the upper cover 22a, which faces an outer circumference portion of the optical disk 9. By this configuration, it is possible to reduce a negative pressure in the cover 22, which is generated by particularly a high speed rotation of the optical disk 9, and it is possible to alleviate depression of the upper cover 22a. That is, a speed on the occasion that the optical disk 9 rotates, is fast at an outer circumference portion, and on that account, a relatively large negative pressure force is easily generated. Therefore, by disposing the through-holes 37 through 40 in a portion of the upper cover 22a, which faces an outer circumference portion of the optical disk 9, as in this embodiment, it is possible to reduce a negative pressure force which is generated at the optical disk 9, and depression of the upper cover 22a is suppressed. In addition, a through-hole 41 is disposed so as to face the spindle motor 7. Meanwhile, in this embodiment, the through-holes 37 through 40 are allocated in a circular shape, centering around the through-hole 41.

In addition, it is desirable that the through-holes 37 through 40 are allocated in a range of diameter Φ 90 mm through 120 mm, centering around a rotation center of the spindle motor 7. By disposing the through-holes 37 through 40 in the above-described range, it is possible to surely suppress reduction of a negative pressure force in a particularly high speed rotation of the optical disk 9. Further, it is desirable that a diameter of the through-holes 37 through 40 is set in a range of Φ 1 mm through Φ 5 mm, and, by setting a size of the through-holes 37 through 40 in this range, it is possible to carry out reduction of a negative pressure force, and in addition, it is possible to suppress lowering of mechanical strength of the upper cover 22a. That is, if a size (diameter) of the through-holes 37 through 40 is less than Φ 1 mm, an effect of negative pressure force reduction is few, and if it is larger than Φ 5 mm, a forming area of the through-holes 37 through 40 becomes large, and there is such a case that strength of the upper cover 22a is lowered.

In this way, by disposing the through-holes 37 through 40, it is possible to prevent the upper cover 22a from sinking in to be in contact with the optical disk 9 or another member, even if a weight of the upper cover 22a is saved and mechanical strength and stiffness are lowered to some extent.

Meanwhile, in this embodiment, four through-holes such as the through-holes 37 through 40 were disposed, but it is all right even if they are three pieces, or two pieces. That is, a plural pieces of through-holes are disposed, and desirably at a predetermined interval, they are allocated in a circular shape, which is desirable.

In addition, the through-holes 37 through 40 are made to be circular shaped holes, but it is all right even if they are made to be rectangular shaped holes, triangular shaped or polygonal shaped more than a pentagon, or at least one of through-holes is made to be different from a shape of other through-holes. In this way, by making a shape of the through-hole different, or making an allocation position (a distance from a center of the spindle motor 7, etc.) of the through-hole different, optimum negative pressure force reduction can be realized.

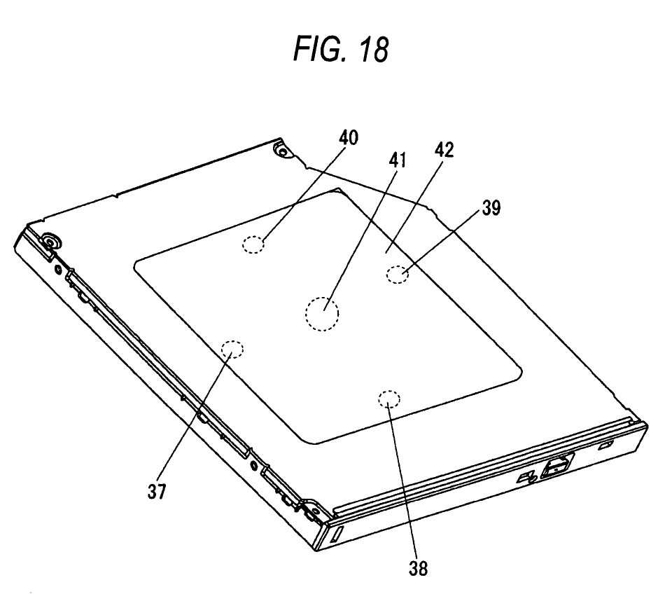

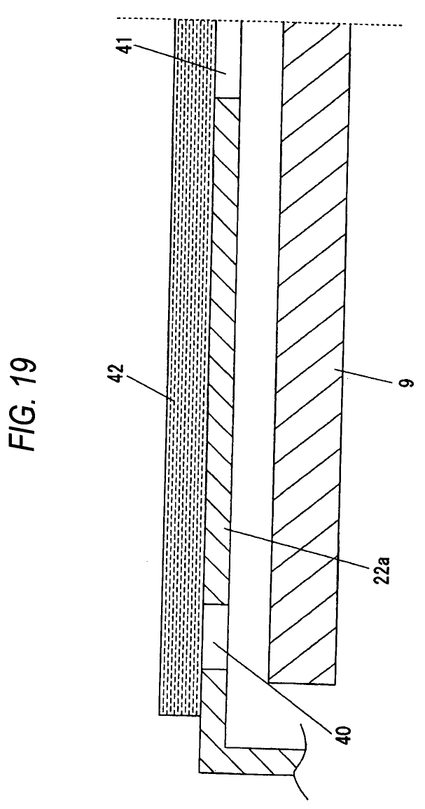

Further, in an embodiment shown in FIGS. 16 and 17, the through-holes 37 through 40 were simply disposed, and therefore, in case of using an apparatus under such a circumstance that there are many dusts outside, there is such a possibility that dusts go into an inside through the through-holes 37 through 40 from an outside. Then, as shown in FIGS. 18 and 19, it is configured in such a manner that a filter member 42, which covers the through-holes 37 through 40, is pasted to the upper cover 22a. In this way, by disposing the filter member 42 through which a gaseous body can pass, it is possible to remove dusts by this filter member 42 even if dusts tries to go into from the through-holes 37 through 40, and it is possible to prevent such a case that dusts go into an inside and a trouble occurs. In addition, in this embodiment, as the filter member 42, a bonded textile, a paper, an expandable sheet, a porous sheet etc. are desirably used. Further, by disposing the filter member 42 on the upper cover 22a in a relatively wide area by adhesion and sticking, reinforcement of mechanical strength of the upper cover 22a is possible, and in addition, it is also possible to describe at least one of a manufacture site, safety signage, an actual manufacturer etc. on the filter member 42, or to describe a sign and a numerical character etc. which correspond to those descriptions.

In addition, in this embodiment, one filter member 42 is disposed so as to cover the through-holes 37 through 40 including the through-hole 41, and thereby, it is possible to cover each through-hole, and therefore, it is possible to improve productivity etc., but it is also possible to configure so as to cover at least one of the through-holes 37 through 40 by one filter member 42. In addition, it is all right even if it is configured in such a manner that a plurality of filter members 42 are disposed to cover each through-hole 37 through 40 individually. In addition, in this embodiment, it is configured in such a manner that all through-holes 37 through 40 were covered by one filter member 42, and in addition, one filter member 42 is configured by an all breathable material, but by configuring a facing portion of the through-holes 37˜40 through the use of a breathable member, and configuring another portion through the use of a normal label, and a portion of the filter member 42, which faces the through-holes 37 through 40, is made by a member which is suitable for signage, and thereby, it is also possible to carry out signage etc.

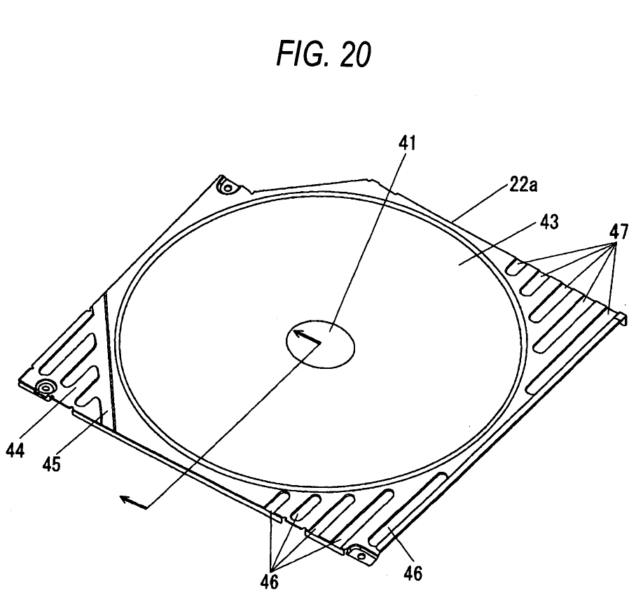

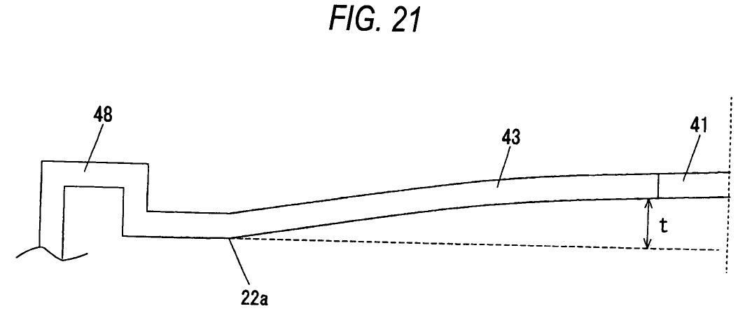

Further, in order to enlarge mechanical strength and stiffness of the upper cover 22a, it is also all right even if it is configured as shown in FIGS. 20, 21 in such a manner that a dome portion 43 is disposed on the upper cover 22a. That is, by disposing the dome portion 43 which protrudes gradually outside the apparatus and toward the through-hole 41, even if a negative pressure force is generated along with a rotation of the optical disk 9 in an inside of the apparatus, there occurs no case in which deformation such as depression is not easily generated on the upper cover 22a even if a force is received in an apparatus inside direction, since the dome portion 43 is disposed. In addition, it is desirable that a forming area of the dome portion 43 to an area of a portion which faces the optical disk 9 with a diameter of 120 mm which is mounted on the spindle motor 7, in other words, a projected area of a disk with a diameter Φ of 120 mm, which is an area of a portion of a diameter 120 mm from a center of the cover 22, in the upper cover 22a is set to 50% or more. When it is smaller than 50%, it becomes difficult to make the upper cover 22a hold desired stiffness.

Supplementarily, stair-like convex portion 44 and concave portion 45 are also disposed on a rear end portion side, outside the dome portion, and mechanical strength is increased, and in the same manner, by also disposing concave portions 46, 47 in a staircase pattern on a front end portion side, mechanical strength is increased.

As shown in FIG. 21, a protruding portion 48 with such a cross-sectional shape that it protrudes outside is disposed between the dome portion 43 and the upper cover 22a outer side surface, and by disposing this protruding portion 48, an outside end portion of the dome portion 43 is depressed once, and then, it is projected outside gradually, and therefore, it is possible to prevent a height of an apex portion (in the vicinity of the through-hole 41) of the dome portion from going up, and a thin type can be realized. In addition, as shown in FIG. 21, it is desirable that a raised height t of the dome portion 43 is set to 0.2 mm˜1 mm, and when it is set to less than 0.2 mm, stiffness of the dome portion 43 does not become a desired size, and when it is larger than 1 mm, realization of a thin type is difficult.

Meanwhile, in this embodiment, an outline of the dome portion 43 is made to be of a circular shape, but it is also all right even if it is of a rectangular shape, a triangular shape, or an elliptical shape, or it is made to be of a polygonal shape more than a polygon. Further, a cross-sectional shape of the protruding portion 48 is made to be of a square shape, but it is also all right even if it is made to be of a shape such as a semicircular shape.

In addition, the dome portion 43 is disposed so as to be lifted up gradually toward the through-hole 41 (a center portion of the spindle motor 7), but it is all right even if it is configured in such a manner that it is lifted up in a staircase pattern by use of a press work etc. As a matter of course, even in a case shown in the embodiment, it is all right even if the dome portion 43 is configured by use of a press work etc.

### Embodiment 2

Next, weight saving of a pickup module will be described.

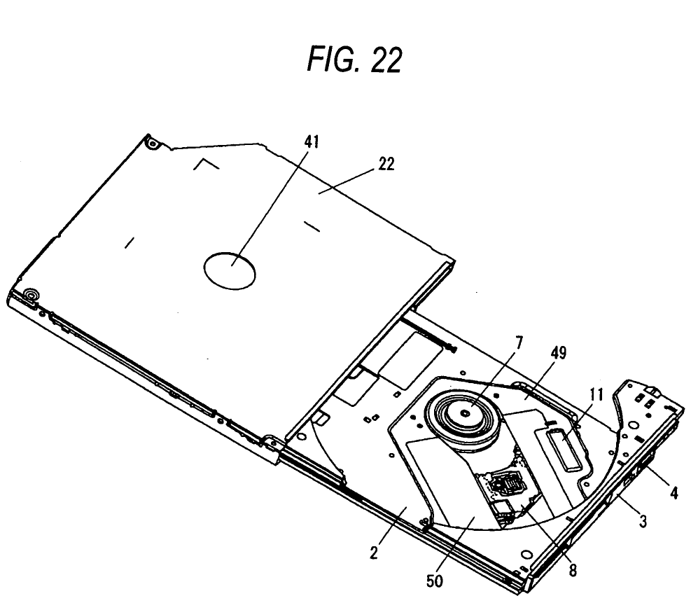

As shown in FIG. 22, the tray is disposed on the cover in such a manner that it can be inserted into and pulled out from the cover, and a bezel 3 and an eject button 4 etc. are disposed on the tray 2. 49 designates a pickup module, and the spindle motor 7 for rotating the optical disk 9 and the carriage 8 are held on the pickup module 49 movably. 11 designates a motor which generates a drive force for moving the carriage 8, and the motor 11 is disposed on the pickup module 49. On the carriage 11, a light source and various optical components, lenses etc. are mounted, and an optical device, which carries out at least one of recording and reproduction of information to the optical disk 9, is mounted.

50 designates a pickup cover which is disposed so as to cover a facing portion of the pickup module 49 and the optical disk 9.

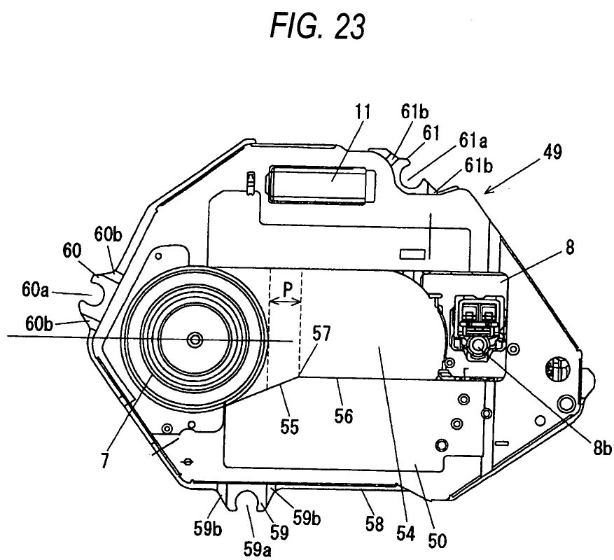

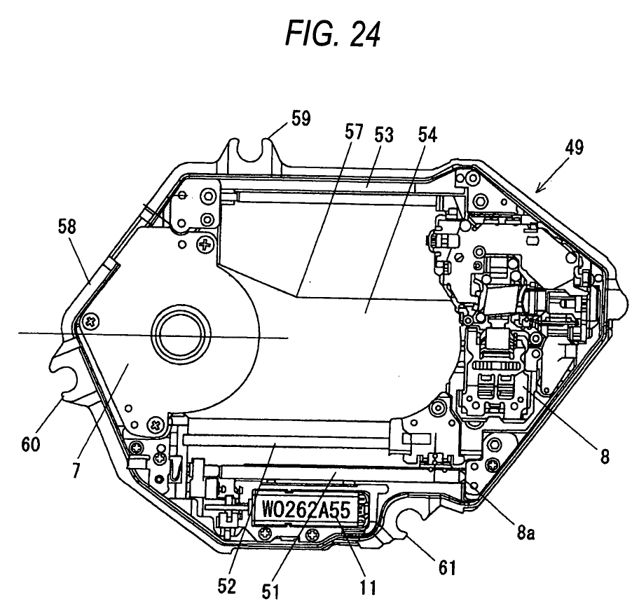

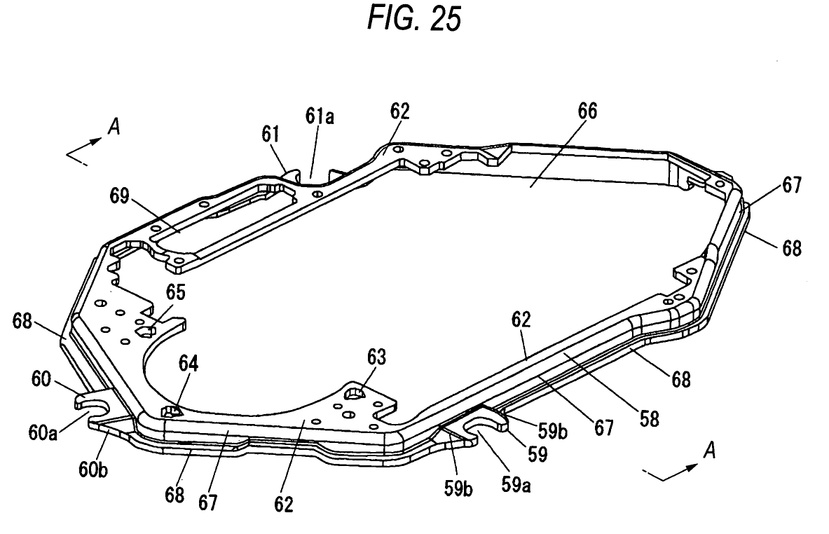

FIGS. 23 and 24 are a front surface view and a rear surface view of the pickup module 49, respectively, and the pickup module 49 is configured in such a manner that each portion is mounted on a pickup frame 58, and the pickup frame 58 is configured as shown in FIG. 25.

On the pickup frame 58, fixing portions 59, 60, 61, which become attaching portions to the tray 2, are disposed. The pickup frame 58 is configured by a flat plate shaped inner portion 62 which is projected internally, a standing-disposed portion 67 which is disposed integrally with the inner portion 62 and an outer portion 68 which is disposed integrally with the standing-disposed portion 67 and is disposed so as to be projected to an opposite side of the inner portion 62, and a cross-section surface is of nearly S-letter shape. In this embodiment, by particularly disposing the outer portion 68, the pickup frame 58 is configured by a lightweight material such as aluminum and aluminum alloy, magnesium alloy, and a wall thickness is thinned in some cases, and thereby, even if mechanical strength is relatively small, it is possible to increase mechanical strength structurally, by particularly disposing the outer portion 68. In addition, through-holes 63, 64, 65 are disposed in the inner portion 62, and screws etc. are inserted into these through-holes 63 through 65, and thereby, the spindle motor 7 is fixed to the pickup frame 58. In addition, a through-hole 66 is disposed in the pickup frame 58, and in this through-hole 66, the carriage 8 etc. are held movably as described later. In addition, another through-hole 69 is disposed in the inner portion 62, and disposed so as for the motor to comes out. Meanwhile, as to the outer portion 68, it is possible to heighten mechanical strength and stiffness, by desirably disposing it at an nearly entire circumference of the pickup module 58, but by disposing the outer portion 68 continuously and discretely on at least more than 50% of the entire circumference of the pickup frame 58, it becomes possible to obtain a certain level of mechanical strength and stiffness.

Fixing portions 59, 60, 61 are disposed integrally with the outer portion 68, and concave type openings 59a, 60a, 61a are disposed in the fixing portions 59, 60, 61. In these openings 59a, 60a, 61a, screws and bosses etc. are inserted through a damper member, and they are fixed to the tray 2. In addition, on both sides of the fixing portions 59, 60, 61, root portions 59b, 60b, 61b, which are configured by a press work etc. and of a squeezed configuration, are disposed. Meanwhile, owing to a circumstance of the drawing, one of the root portions 60b and both of the root portions 61b are not shown in the figure. In this way, by disposing the root portions 59b, 60b, 61 b with a squeezed configuration on both side portions of the fixing portions 59, 60, 61, it is possible to increase mechanical strength of the fixing portions 59, 60, 61, and it makes it difficult to generate twist etc. on the pickup frame 58 when it is attached to the tray 2.

In addition, in this embodiment, a squeezed configuration is adopted for all of the root portions 59b, 60b, 61b of the fixing portions 59, 60, 61, but by disposing at least one, it is possible to eliminate a trouble as compared to the past, and in addition, in the embodiment, three fixing portions 59, 60, 61 were disposed, but it is all right even if at least two are disposed, or it is desirable to dispose four or more and eight or less.

As shown in FIG. 24, the spindle motor 7 is fixed to the pickup frame 58, and in addition to that, a drive shaft 51, guide shafts 52, 53 etc. are fixed thereto nearly in parallel, and the carriage 8 is held in these guide shafts 52, 53 movably, and furthermore, a rack portion 8a, which is disposed on the carriage 8, is engaged with the drive shaft 51. Although it is not shown in the figure, a spiral groove is disposed in the drive shaft 51, and the rack portion 8a is engaged with this spiral groove, and it is configured in such a manner that, when more than a predetermined load is applied, this rack portion 8a is disengaged from the spiral groove, which prevents breakage etc. of the drive shaft.

The pickup cover 50 is of such a configuration that it is lightweight in the same manner as other members and further, relatively thin, and becomes easily deformed. A through-hole 54 is disposed in the pickup cover 50, and from this through-hole 54, a side of the carriage 8, which an objective lens 8b looks out on, comes out, and an attaching portion of the optical disk 9 on the spindle motor 7 is projected. As described above, for the purpose of weight saving, the pickup cover 50 becomes easily deformed, and therefore, it is configured as shown in FIG. 23 etc. so as to dispose a corner portion 57 where a parallel portion 56 which is equivalent to an inner end portion of the pickup cover 50, which configures the through-hole 54 and is further parallel to a moving direction of the carriage 8 and a non-parallel portion 55 which makes a gap gradually, as it comes free from the spindle motor 7 and is further non-parallel to the moving direction of the carriage 8 intersect with each other. That is, by configuring so as to dispose the corner portion 57 in a moving range of the carriage 8, an angle of the corner portion 57 can be enlarged, and it is possible to increase mechanical strength in the vicinity of the corner portion 57 by just much. In case of such a configuration that the corner portion 57 is extremely close to the spindle motor 7 as in the past, the corner portion becomes sharp by any means, and when the vicinity of the corner portion is mistakenly pressed by a hand etc., there is such a case that it is easily deformed, but by allocating the corner portion 57 in a movable range of the carriage 8 as in this embodiment, it is possible to enlarge an angle of the corner portion 57, and it is possible to increase mechanical strength by just that much. Meanwhile, as shown in FIG. 23, it is desirable that a distance P of the corner portion 57 and an end portion of the spindle motor 7 along a moving direction of the carriage 8 is set to 5 mm˜30 mm. When it is smaller than 5 mm, the corner portion 57 becomes sharp in the same manner as in the past, and it is difficult to increase mechanical strength, and when it is larger than 30 mm, a portion which the pickup cover 50 covers becomes narrow, and there is such a possibility that a sufficient effect of the cover can not be obtained.

### Embodiment 3

An interval of an optical disk and the upper cover is configured to be approximately from 0.5 mm to 2 mm, in case of carrying out weight saving. The optical disk rotates more than 5000 RPM at the time of high speed. At this time, when Reynolds number of air in a gap which is sandwiched by the optical disk and the upper cover is calculated,
Re=V.L/ν is obtained.

Re designates Reynolds number, and V designates a flow rate, and L designates a representative length, and μ designates a dynamic coefficient of viscosity. A diameter of the optical disk is 12 cm, and assuming that a rotation number is 5400 RPM and a representative length is ½ of the optical disk and the upper cover and ν is air, when Reynolds number at an optical disk outer circumference is calculated,

$$\begin{matrix}Re = ( 12 \times π \times 5400 / 60 ) \cdot ( 0.025 ∼ 0.1 ) / 0.15 \\ = 565 ∼ 2262 \end{matrix}$$

It is generally known that, in case that the Reynolds number is 3000 or less, a laminar air flow is realized. Thus, in this case, air is to move at high speed in a state of the laminar air flow, and a strong sucking force is to be generated between the optical disk and the upper cover. In addition, in order to convert this laminar air flow into a turbulent flow for the purpose of reducing the sucking force, it becomes possible to realize it by disposing small concave portion, convex portion or both of them.

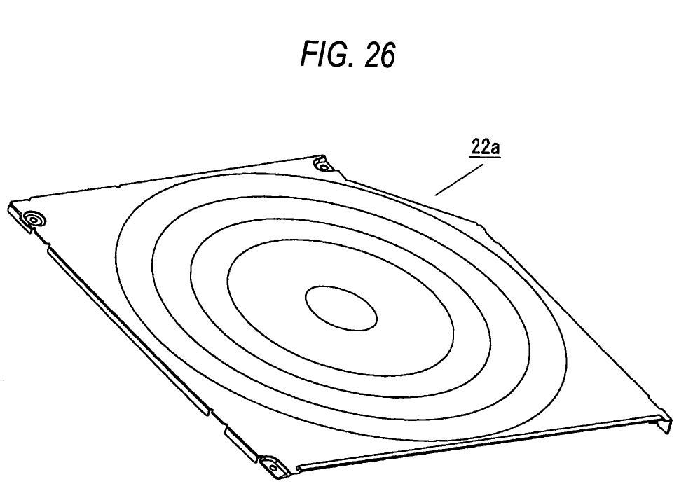

In the meantime, the upper cover 22a is configured by a plate material of a thin plate material which includes a lightweight metal material, and as the lightweight metal material, aluminum, aluminum alloy, magnesium alloy, titanium, titanium alloy etc. are desirably used, and it is configured by processing a plate material which is configured by at least one of those materials. In addition, for the purpose of weight saving, a radial thickness of the upper cover 22a becomes thin, and mechanical strength is relatively lowered. Then, in order to improve strength over reducing a sucking force which is generated when the optical disk rotates, it is configured as shown in FIG. 26, in such a manner that a ring shaped concave portion (or convex portion), which is concentric with the optical disk, is disposed on the upper cover 22a.

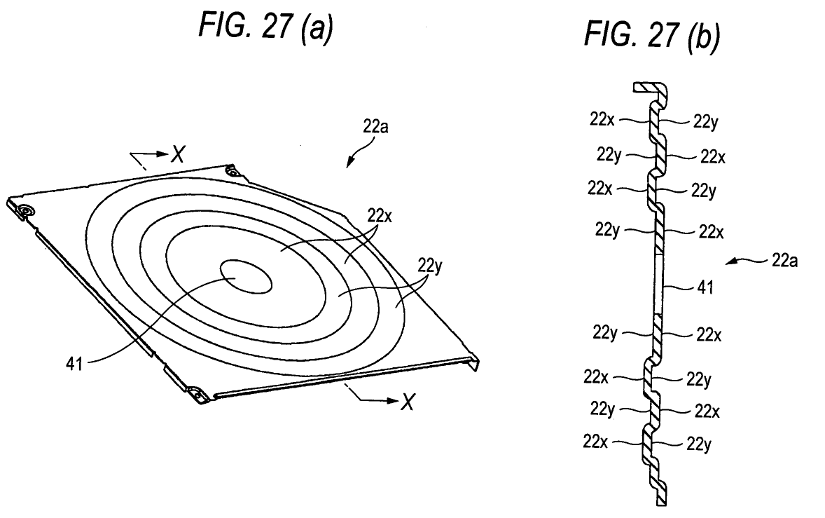

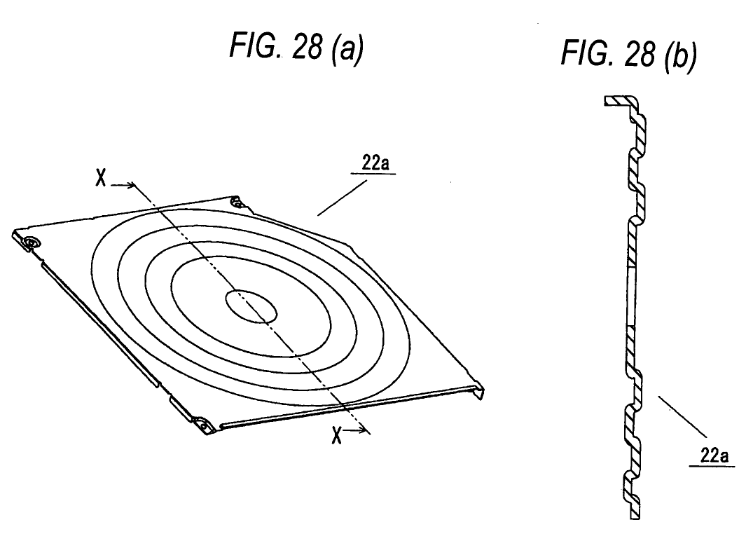

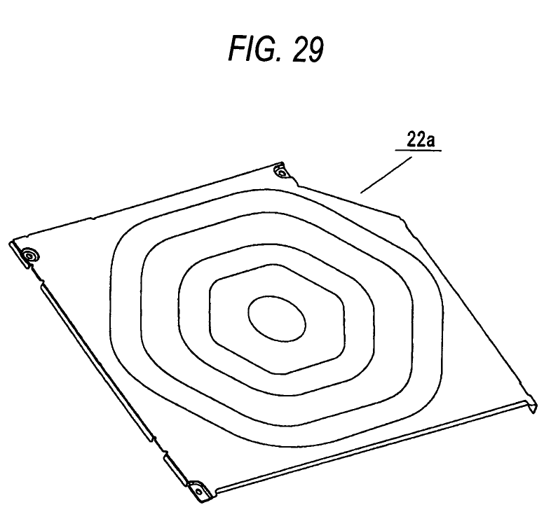

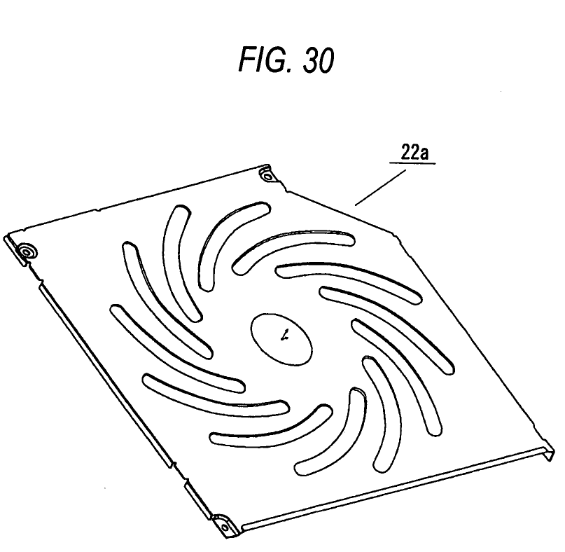

In addition, a cross-sectional surface of the upper cover 22a is shown in FIGS. 27 and 28. By disposing the ring shaped concave portion which is nearly concentric with the optical disk, it operates as a convex portion (or concave portion) which generates a turbulent flow in an air layer which is sandwiched by the optical disk and the upper cover 22a, and the ring shape improves stiffness of a flat surface to a depression direction, and therefore, it is possible to effectively suppress depression of the upper cover 22a. Meanwhile, here, the ring shaped concave portion (or convex portion) is disposed, but it is all right even if it is configured by a continuous combination of a polygonal shape of more than a triangle or a shape which has a resemblance to the polygonal shape (in case of FIG. 29, it is a hexagon, and corner portions are coupled by R), or an elliptical shape, a convoluted shape (FIG. 30), and a circular arc shape. Further, a cross-section shape of the convex portion (or concave portion) is made as a square shape (a corner R portion due to processing is neglected here), but it is all right even if it is made as a shape such as a semicircular shape.

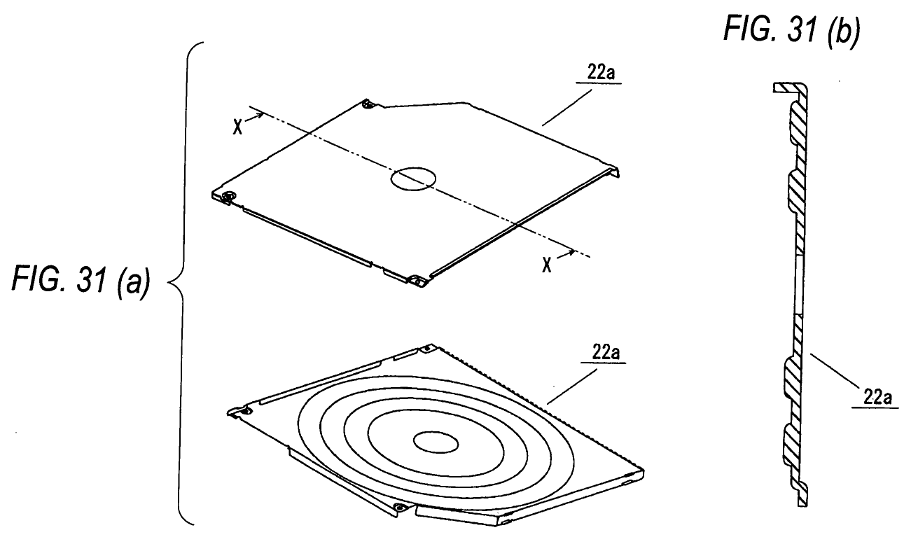

In addition, as shown in FIG. 31, it is apparent that a similar effect can be obtained, even by forming only the convex portion (or concave portion), for the purpose of generating a turbulent flow layer. In this case, it is all right even if the convex portion (or concave portion) is configured by the same member as that of the upper cover 22a by a press work, a casting work, a cutting work etc., but it is all right even if another member is pasted by an adhesive agent, a pressure bonding system etc.

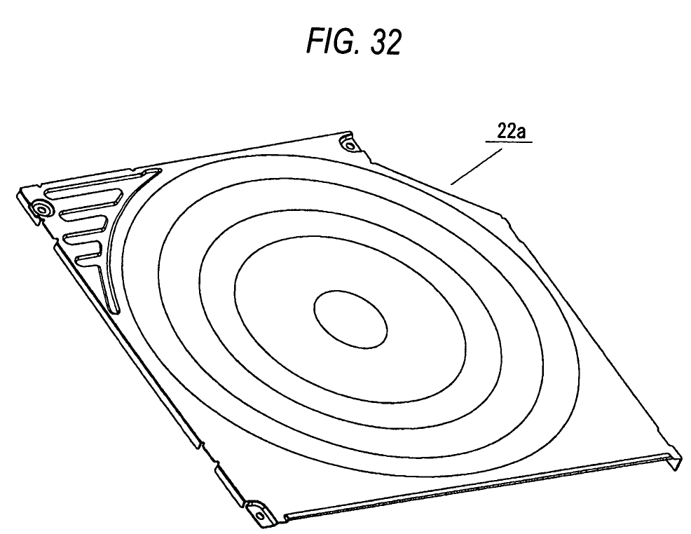

Furthermore, as shown in FIG. 32, it is all right even if a convex portion (or concave portion) is disposed for the purpose of further realizing improvement of strength, on an outside of the ring shaped polygonal shaped convex portion (or concave portion) which is described so far.

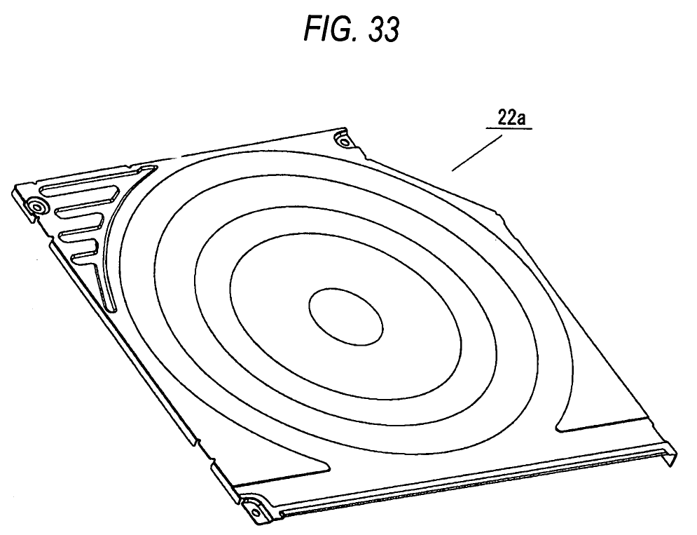

In addition, since there is such a necessity that the optical disk apparatus is structurally configured in such a pouch shape that one place is opened at minimum, in order to pull out an optical disk, strength of a pull-out portion of an optical disk on the upper cover 22a is lowered. Consequently, as shown in FIG. 33, it is all right even if a convex portion (or concave portion) is disposed on the pull-out portion of an optical disk.

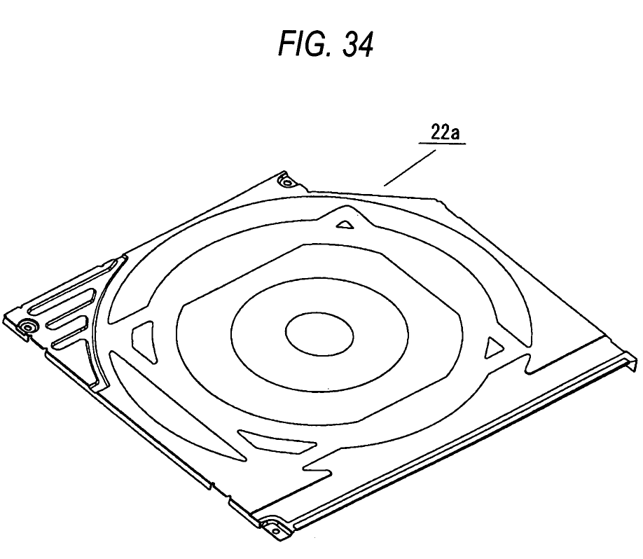

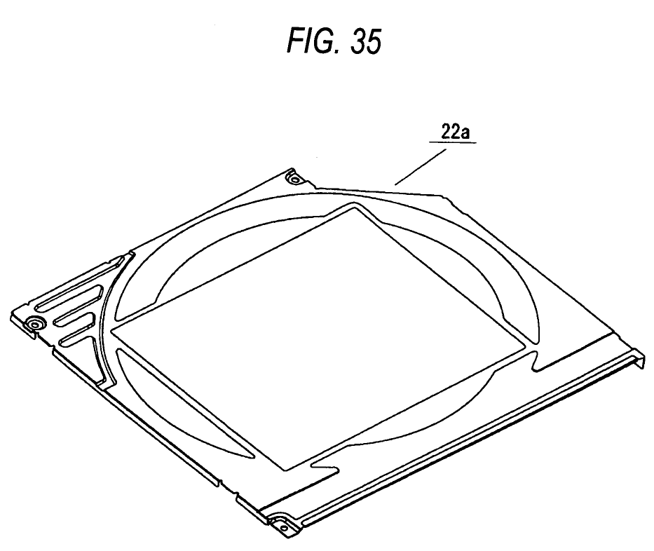

Further, there is need to paste a name plate on which a model name, a type, a notabilia etc. were described on the optical disk apparatus. Thus, as shown in FIG. 34 (such a state that a name plate is not pasted) and FIG. 35 (such a state that the name plate is pasted), it is all right even if a part of the ring shape is deformed and convex portions are continued, in tune with an outer circumference shape of a name plate.

Furthermore, by such a configuration that a part of the convex portion (or concave portion) is deformed and convex portions were continued, an improvement level of strength due to the convex portion (or concave portion) is lowered, and therefore, in order to compensate this and improve strength, it is all right even if an additional convex portion (or concave portion) is disposed in the vicinity of continued convex portions.

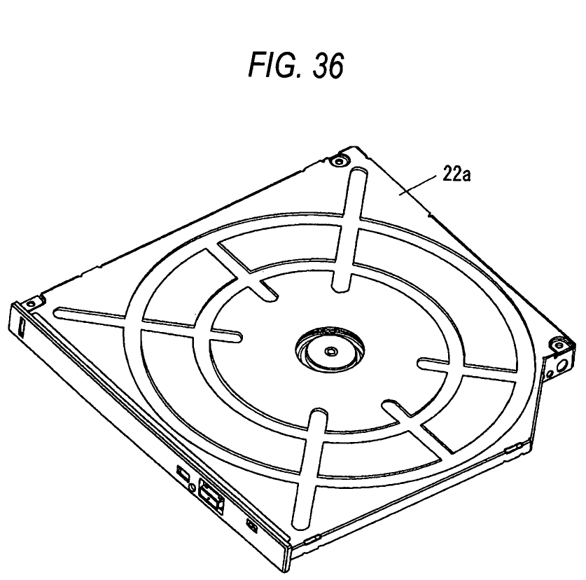

In addition, as shown in FIG. 36, it is all right even if strength of the upper cover 22a is improved by combining with a radial convex portion (or concave portion).

In addition, a difference of elevation of the convex portion (or concave portion) is different depending on a distance of the upper cover 22a and the optical disk 9, and it is confirmed by experimentation that, for example, when a distance of the upper cover 22a and the optical disk 9 is approximately 1 mm, even if it is 0.1 through 0.2 mm, a sufficient effect can be obtained.

In addition, in forming the convex portion (or concave portion), since the upper cover 22a is in a thin plate shape, mass production becomes easy by configuring the convex portion (or concave portion) by use of a press work.

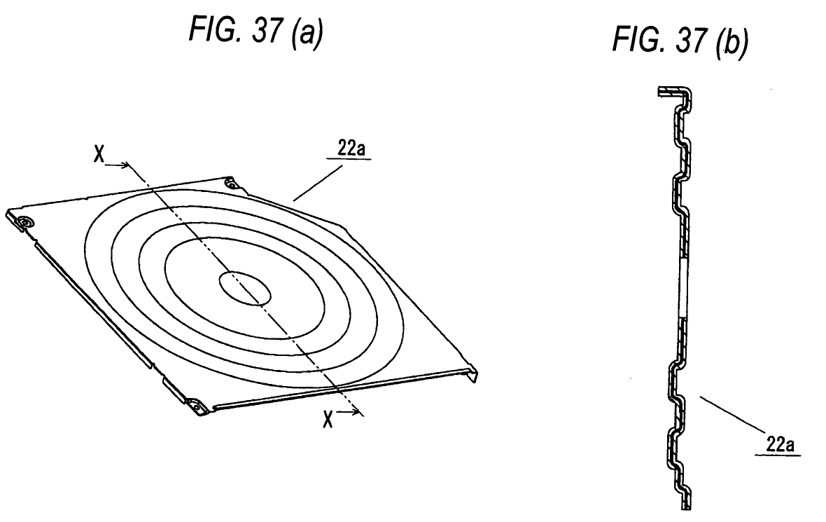

In addition, in the above-described explanation, it is described as to such a case that it is configured by one king of a lightweight material, but as shown in FIG. 37, by configuring through the use of a material with a sandwich structure in which an inner layer is configured by use of a lightweight material and an outer layer is configured by use of a material with high strength and stiffness, it is possible to carry out much further weight saving without dropping down strength and stiffness of the upper cover 22a. As an example, it is possible to configure the inner layer by resin, magnesium and magnesium alloy, and to configure the outer layer by aluminum and aluminum alloy, titanium and titanium alloy, nickel and nickel alloy, iron and iron alloy.

As above, it is configured in such a manner that strength of the upper cover 22a is tried to be improved by the convex portion (or concave portion) of a ring shape etc. and a turbulent flow is generated in an air layer which is sandwiched by an optical disk and the upper cover 22a, but even if it is not a shape by which strength is improved such as the ring shape from the viewpoint of a structure or design, by disposing an arbitrary shaped convex portion (or concave portion) only for the purpose of generating a turbulent flow, it is also possible to reduce depression of the upper cover 22a to some extent.

### Embodiment 4

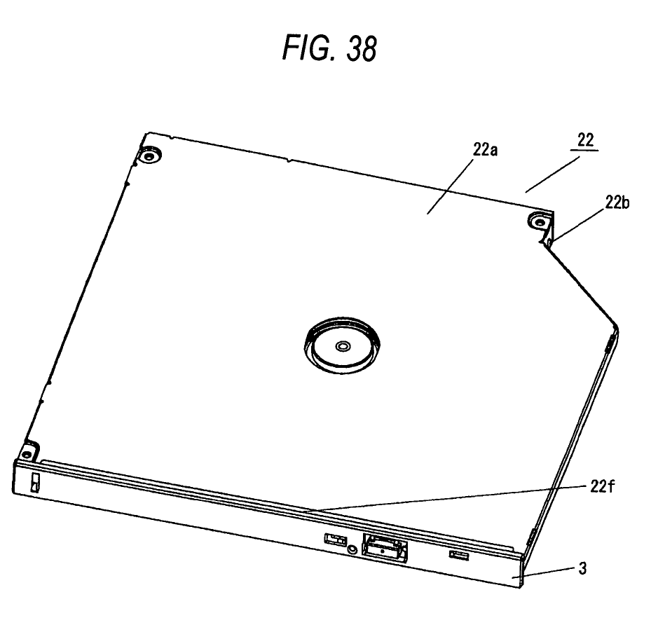

FIGS. 38 through 48 are views which show an optical disk apparatus in an embodiment 4 of the invention, respectively. Meanwhile, the same things as reference numerals and signs shown in FIGS. 76 through 83 are configured by similar shapes, configurations, materials. FIG. 38 is a perspective view which shows the optical disk apparatus in the embodiment 4 of the invention. In FIG. 38, 22 designates a cover, and the cover 22 is configured by joining an upper cover 22a and a lower cover 22b through the use of at least one of joining means such as screws, an adhesive agent and a locking member. The cover 22 has an aperture 22f, and is configured in a pouch shape. As shown in FIG. 38 in such a state that the tray 2 is put in the cover 22, it becomes such a configuration that the aperture 22f is covered by a bezel 3. In addition, at least the lower cover 22b (as a matter of course, including a case of both of the upper cover 22a and the lower cover 22b) out of the cover 22 is formed by a plate material or a thin plate material which includes a lightweight metal material, and as the lightweight metal material, aluminum, aluminum alloy, magnesium alloy, titanium, titanium alloy etc. are suitably used, and by processing a plate material which is configured by at least one of those materials, the lower cover 22b is configured. In addition, in the embodiment 4, particularly in consideration of a cost phase and a characteristic phase, aluminum or aluminum alloy is used. In addition, as another embodiment, it is all right even if a multilayer structure is formed by combining plate materials which were configured by the above-described lightweight metal material, each other. For example, it is all right even if the lower cover 22b is configured by combining an aluminum thin plate and an aluminum alloy thin plate, and it is all right even if it is configured by laminating a plurality of an aluminum thin plate and a thin plate which consists primarily of another metal material. In addition, it is all right to use such a compound lightweight plate that a thin plate, which is configured by nickel and nickel alloy, is pasted on both side surfaces of a resin sheet and a resin plate. In addition, it is desirable that at least a thickness of the lower cover 22b is set to 0.15 mm˜0.5 mm, and in case that it is thinner than 0.15 mm, mechanical strength is lowered very much, and there is such a possibility that a trouble occurs, and when it is made thicker than 0.5 mm, it becomes difficult to carry out weight waving.

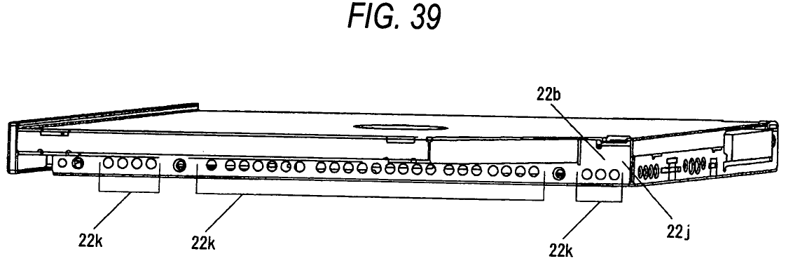

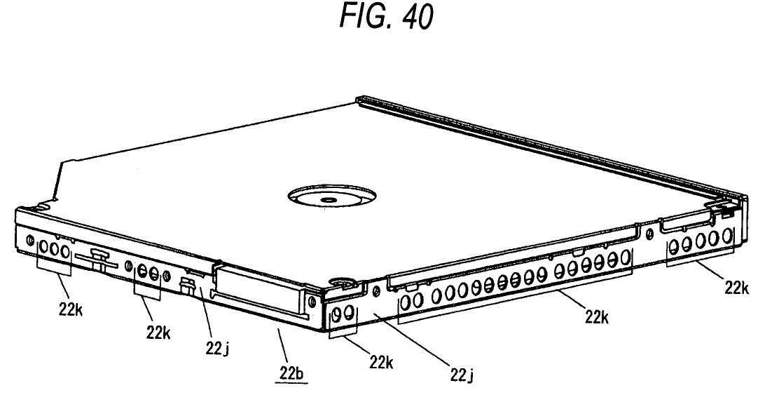

FIGS. 39 and 40 are such things that a plurality of adjacent holes 22k with the same shape were disposed, in a vertical wall portion 22j (a surface which is configured by a surface which is perpendicular to an optical disk) of the lower cover 22b. If it is configured in such a manner that an end portion of the vertical wall portion 22j does not become a hole, for stiffness of the lower cover 22b, there is almost no effect even if a hole is disposed. Therefore, by disposing a plurality of adjacent holes 22k with the same shape in the vertical wall portion 22j, it becomes possible to carry out weight saving with maintaining stiffness and strength, without thinning a board thickness of the lower cover 22b.

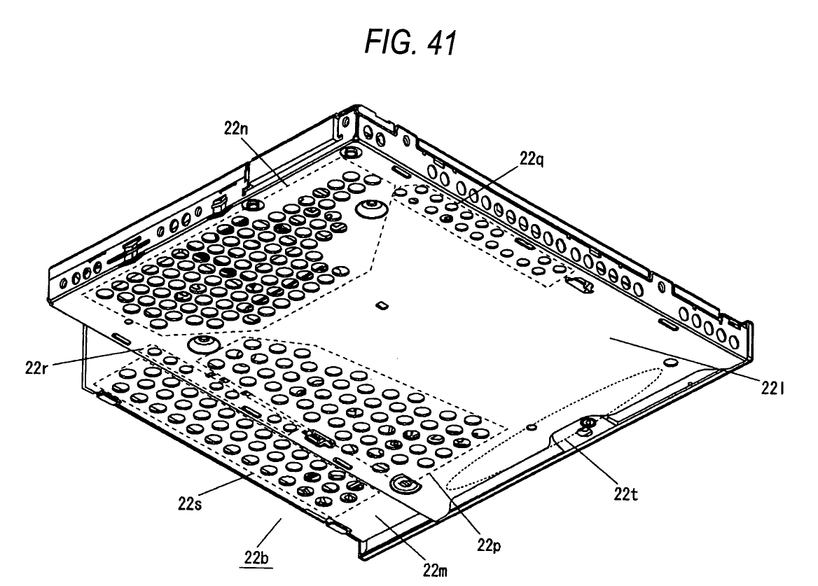

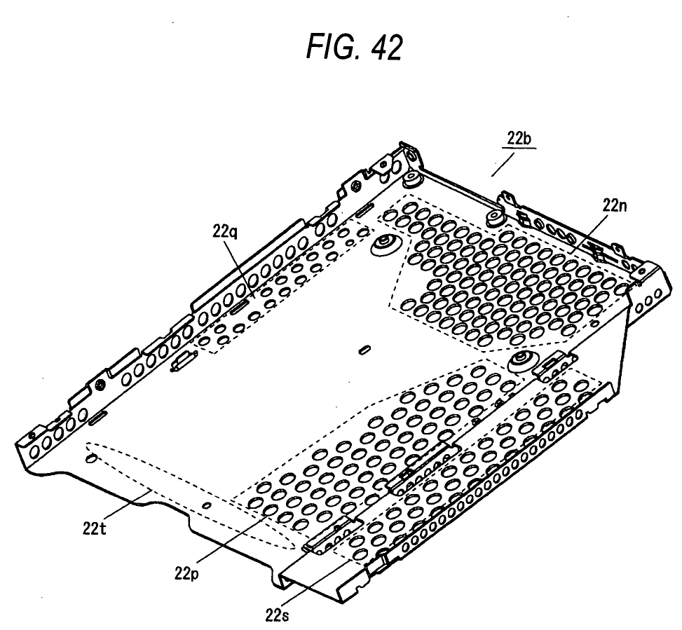

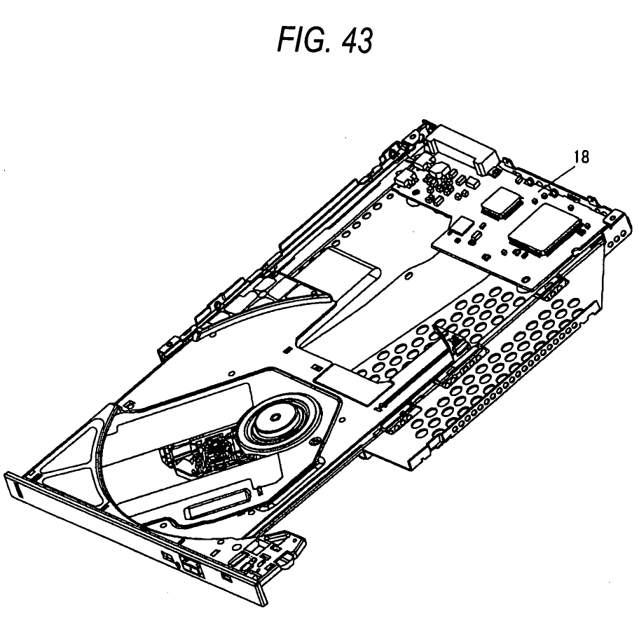

Next, FIGS. 41 and 42 are such things that a plurality of adjacent holes 22n, 22p, 22q, 22r, 22s with the same shape were disposed in a flat surface portions 22l, 22m (a surface which is configured by a surface which is parallel to an optical disk) of the lower cover 22b. for stiffness of the lower cover 22b, it is apparent that an effect regarding stiffness becomes larger in a hole is disposed, in a portion which is close to a front portion 22t which does not have the vertical wall. Here, in order to pull out an optical disk in the optical disk apparatus, as shown in FIG. 43, there is need to pull out the tray 2, and a control substrate 18, which requires a large space, is allocated at a position which is opposite to a pullout direction of the tray, for the purpose of opening and closing of the tray 2. This portion is surrounded by vertical walls on three sides, and furthermore, there is a distance even from the front portion, and therefore, even if a hole is disposed, such a level that stiffness is lowered is small. Therefore, in the flat surface portion of the lower cover 22b, by pitting a hole 22n at a position which is opposite to the control substrate 18, it becomes possible to carry out weight saving with maintaining stiffness and strength, without thinning a board thickness of the lower cover 22b.

In the meantime, an electromagnetic wave is generated without fail, from the control substrate 18, and there is such a possibility that it has an bad impact on another electronic device. In addition, in the control substrate of the optical disk apparatus, it is worried about such a thing that an electromagnetic wave with up to approximately several GHz has an impact on another electric device. Generally, it is suitable that a size of the hole is approximately ¼ or less of a wavelength, and therefore, for example, thinking in a range of approximately 10 GHz or less, ¼ of a wavelength becomes 7.5 mm. Thus, it is desirable that a size of the hole is 10 mm or less as a diameter in case of a circular form, and as a maximum aperture length in case of non-circular form.

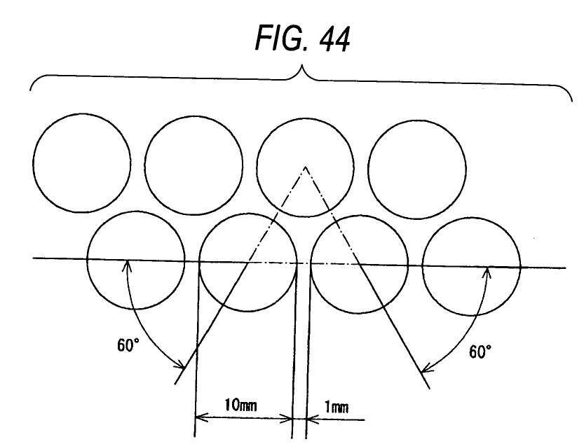

Next, as to an aperture ratio, thinking the time when a size of the hole is 10 mm, weight saving becomes possible by much more narrowing an interval between holes. In case of configuring a shape as shown in FIG. 44 by use of aluminum, aluminum alloy, magnesium alloy, titanium, titanium alloy, a press work is suitable in consideration of mass productivity, but in case of carrying out a press work, it is desirable that the narrowest width portion between holes is set to approximately 1 mm or more. Thus, a number of holes can be pitted most effectively, in case that holes are laid out with a dimensional relationship as in FIG. 44, in case of a circular shaped form. An aperture ratio at this time becomes,
[5×5×π÷2]÷[11×5.5√(3)÷2]=39.27÷52.394≅0.75=75%

It is possible to slightly heighten an aperture ratio, by making a shape of the hole a hexagon, and by narrowing an interval between holes, and therefore, in case of realizing the highest weight saving without an electromagnetic wave's having an effect on an outside electronic device and in such a state that strength and workability of a material were secured, it is possible to set approximately 80% to a maximum aperture ratio, and it is not desirable to set the aperture ratio more than this, from the viewpoint of processing.

However, in order to carry out much further weight saving, in case of taking a maximum aperture portion length larger, in order to prevent an electromagnetic wave from leaking, a sheet material is pasted (not shown in the figure) on the lower cover 22b so as to cover a hole, by use of a sheet material which is configured by an electric conductive material, and a sheet material having an electric conductive layer, and thereby, simultaneous pursuit of weight saving and electromagnetic wave leakage prevention becomes possible.

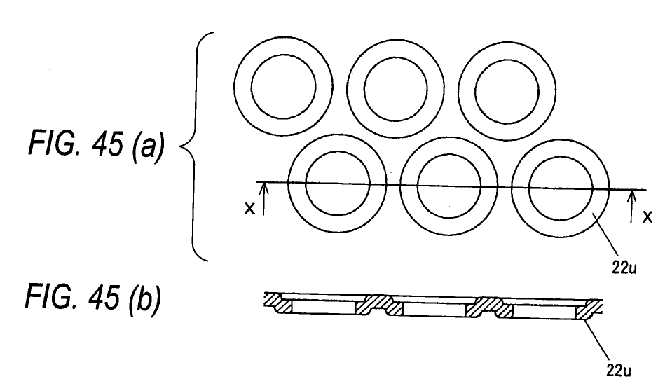

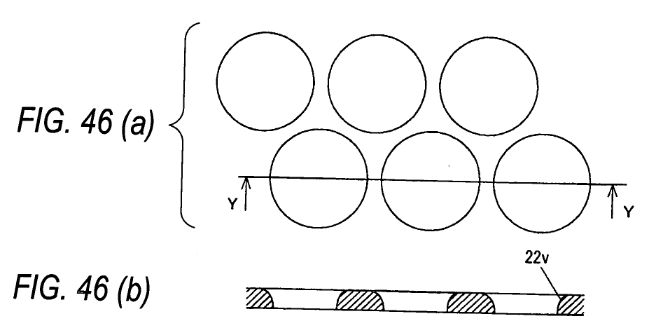

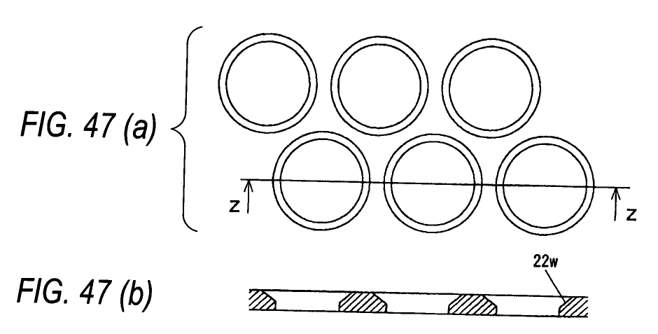

Further, as shown in FIG. 45, by disposing a step portion 22u at a peripheral portion of a hole, it is possible to prevent such a thing that, when the tray is pulled out and inserted, it gets stuck on an end portion of the hole, and in addition, it is possible to improve stiffness of the cover, which is lowered by pitting the hole. For the purpose of preventing such a thing that it gets stuck on an end portion of a hole, as shown in FIGS. 46 and 47, it becomes possible to obtain a similar effect by disposing an R portion 22v or a C surface portion at a peripheral portion of the hole.

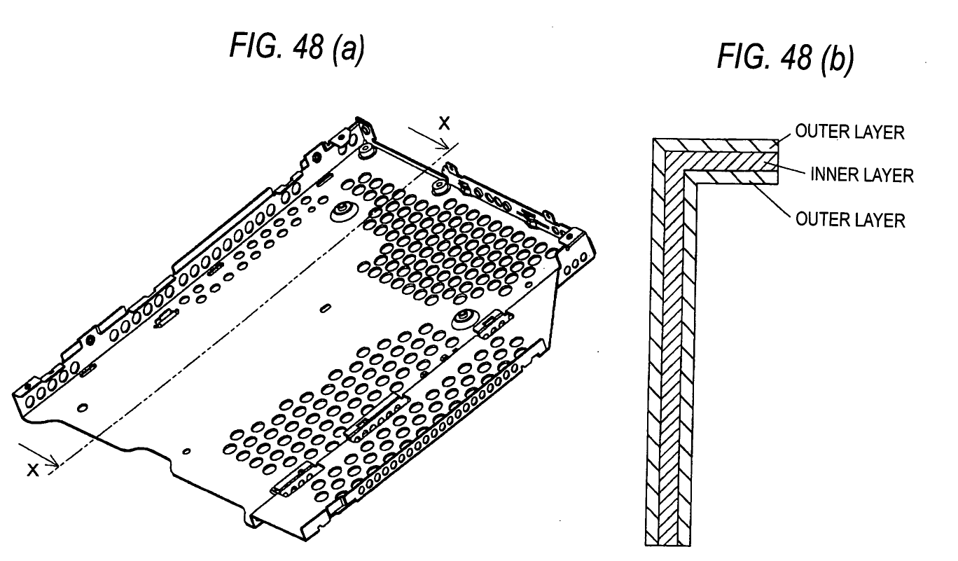

In addition, in the above-described explanation, it is explained in such a case that it is configured by one kind lightweight material, but as shown in FIG. 48, by configuring through the use of a member of a material with a sandwich structure in which an inner layer is configured by use of a lightweight material and an outer layer is configured by use of a material with high strength and stiffness, it is possible to carry out much further weight saving without dropping down strength and stiffness of the lower cover 22b. As an example, it is possible to configure the inner layer by resin, magnesium and magnesium alloy, and to configure the outer layer by aluminum and aluminum alloy, titanium and titanium alloy, nickel and nickel alloy, iron and iron alloy.

In addition, in this embodiment 4, these explained holes are through-holes. Meanwhile, even if they are not made to completely pass through, an equivalent effect can be expected even when a depression is formed by lopping off the cover, but it is desirable that they are through-holes.

### Embodiment 5

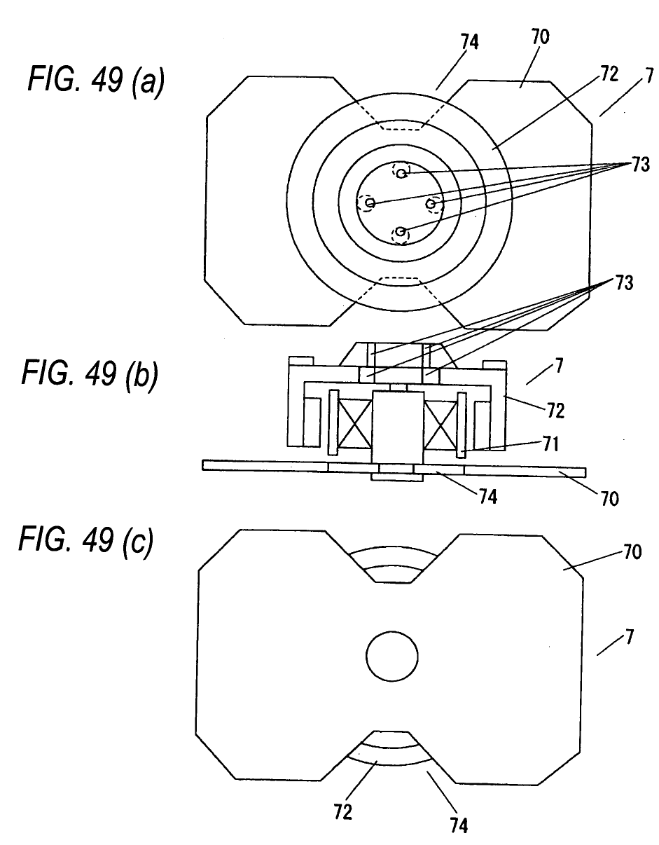

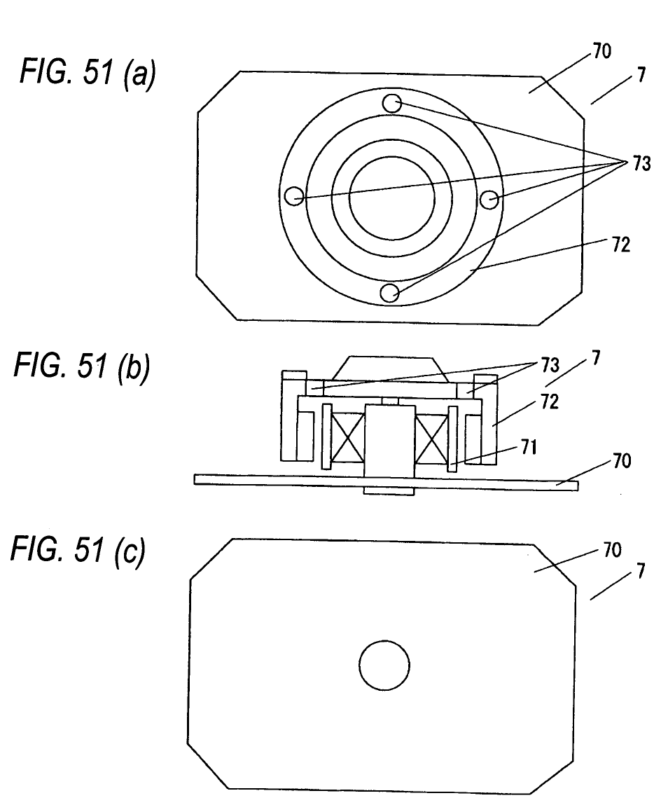

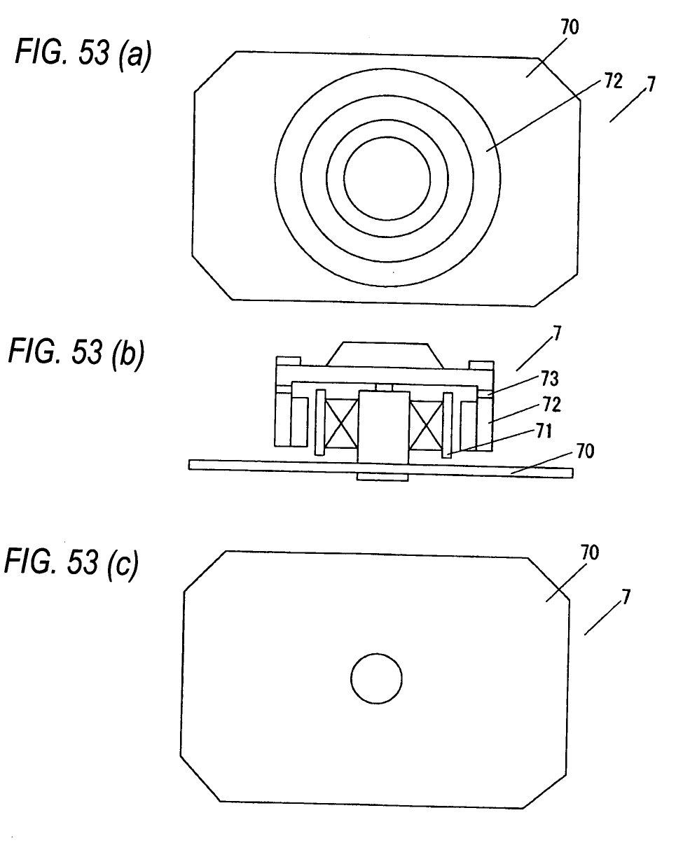

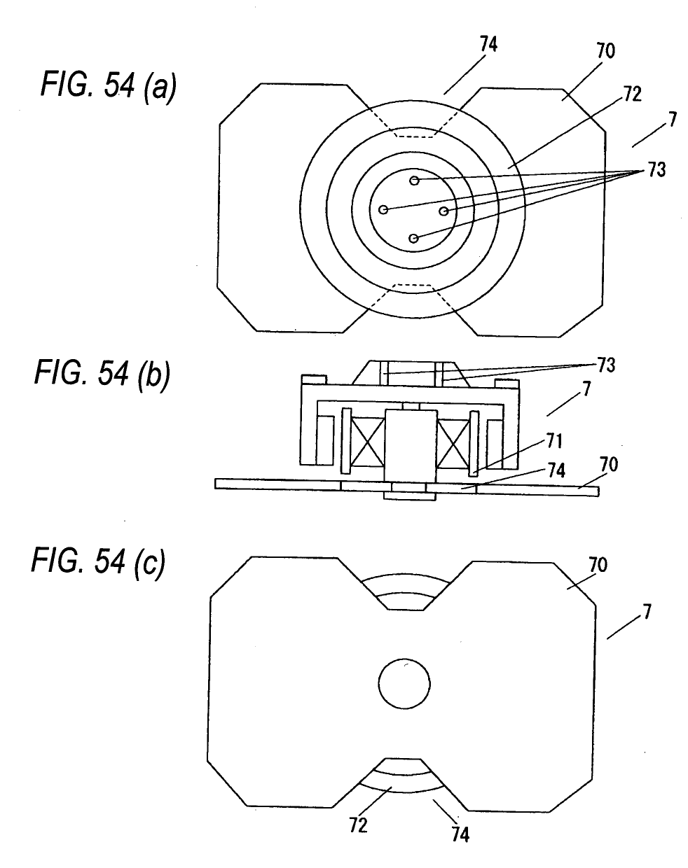

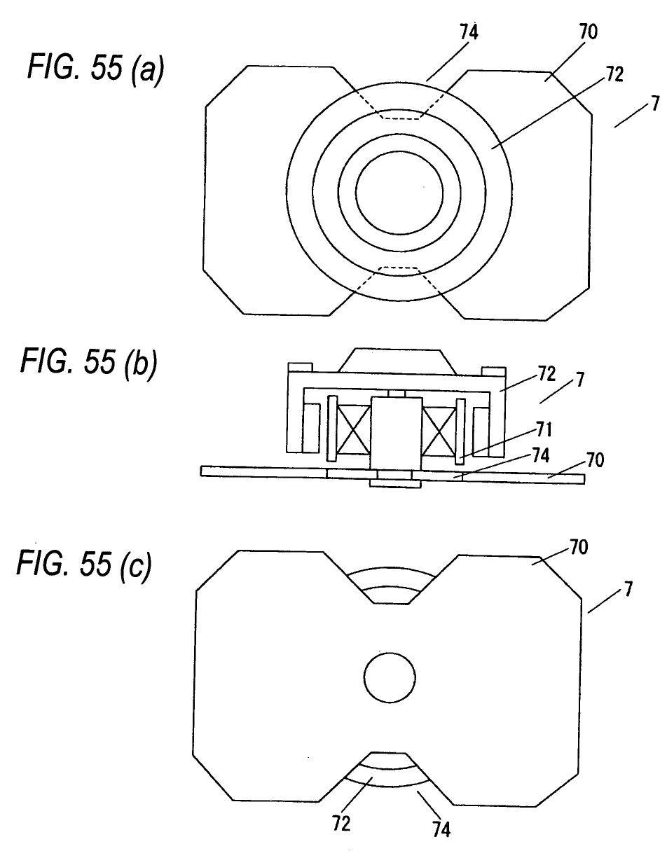

FIGS. 49 through 55 are views which show an optical disk apparatus in an embodiment 5 of the invention, respectively. Meanwhile, the same things as reference numerals and signs shown in FIGS. 76 through 83 are configured by similar shapes, configurations, materials.

In the optical disk apparatus in this embodiment, a plurality of openings 73 were disposed on a top surface and a side surface of a rotor 72 as shown in FIGS. 49 through 54, redressing the balance of positions and sizes. By this configuration, it is possible to realize weight saving of the spindle motor 7, and by disposing effective openings 73 in the spindle motor 7, heat, which is generated in an inside of an optical disk, can be thermally diffused, by utilizing rotation of the rotor 72 and by forming a flow path of heat which passes through the opening 73, and thermal elevation of the optical disk apparatus can be prevented.

Meanwhile, in the optical disk apparatus in this embodiment, it is configured by disposing the opening 73 in a part of the rotor 72, but it is possible to configure it by disposing a concave portion (not shown in the figure) in a part of the rotor 72, in a similar fashion.

As a practical matter, in an inside of the optical disk apparatus, there is a heat generation source such as a laser diode driver which is mounted on an optical pickup and IC of a circuit substrate. Particularly in a thin type optical disk apparatus, components are closed up in a narrow space, and there is such a trend that heat is easily accumulated in an inside of the optical disk apparatus. In addition, in a writing type such as CR-D/RW, DVD-R/RW, and DVD-RAM, heat generation due to a laser diode is larger than that of a reading type such as DVD-ROM. On that account, particularly in an optical disk apparatus of such a type that it is incorporated in a personal computer, temperature in the vicinity of an optical pickup etc. reaches to 70° C. through 80° C. In addition, it goes up to 20° C. or more, and internal temperature of the optical disk apparatus can reach to 100° C. or more. The suchlike high temperature state becomes a cause for shortening a laser diode life. In addition, under the suchlike high temperature state, it becomes impossible for the optical disk apparatus to guarantee a normal operation, and therefore, it stops a function on a mandatory basis.

Consequently, in the optical disk apparatus in this embodiment, by disposing the opening 73 and a concave portion in the rotor 72, a flow path, by which air flows through the opening 73 and the concave portion, is configured. Normally, an optical pickup and a circuit substrate are allocated on a lower surface of an optical disk, and therefore, heat is easily accumulated on the lower surface of the optical disk to easily become high temperature. If this heat can be diffused in an inside of the optical disk apparatus, it is possible to suppress rise in temperature.

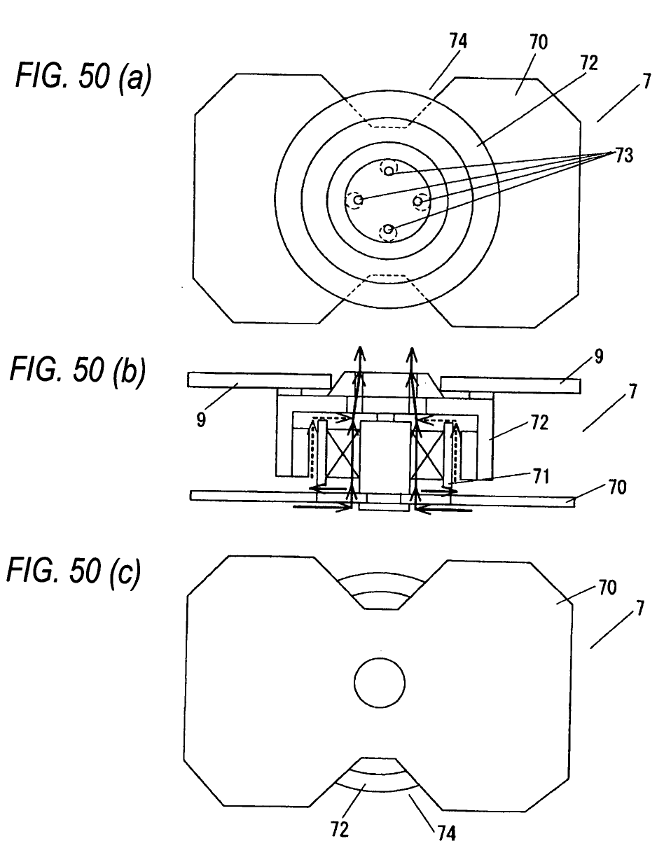

In this embodiment, for this diffusion of heat, rotation of the rotor 72 and an optical disk which rotates together with the rotor 72 is utilized. By rotating the rotor 72, heat on the lower surface of the optical disk 9 is diffused to an upper surface of the optical disk 9. As a heat flow path, a negative pressure, which is generated by rotation of the rotor 72, is utilized. A clearance between the optical disk 9 and the upper cover 22a becomes approximately 1 mm, and an area with a diameter Φ 120 mm from a center of the optical disk 9 is a flat surface. While on the other hand, a clearance of the lower surface of the optical disk 9 is large, and in addition, there is also an aperture in a pickup module which exits on the lower surface of the optical disk 9, and therefore, when the optical disk 9 rotates, a negative pressure is generated on the upper surface side of the optical disk 9. Also by an operation of the negative pressure, as shown in FIG. 50, it is possible to configure a heat flow path which passes from the lower surface of the optical disk 9 through the opening 73 or the concave portion of the rotor 72 to a top of the optical disk 9. On that account, heat on the lower surface of the optical disk 9 runs away upward, and thereby, heat is diffused, and as a result, it also becomes a heat countermeasure of the optical disk apparatus.

In addition, in the optical disk apparatus in this embodiment, a plurality of openings 73 were disposed on the rotor 72, redressing the balance of positions and sizes. By this means, there occurs no case in which unwanted vibration due to unbalance is generated, when the rotor 72 of the spindle motor 7 rotates at high speed.

In addition, the optical disk apparatus in this embodiment is configured, as shown in FIGS. 49 through 54, by disposing the opening 73 and the concave portion on an upper surface and a side surface of the rotor 72, and is also configured by combining these, and thereby, it becomes easy for air to escape to an upper side of the optical disk 9.

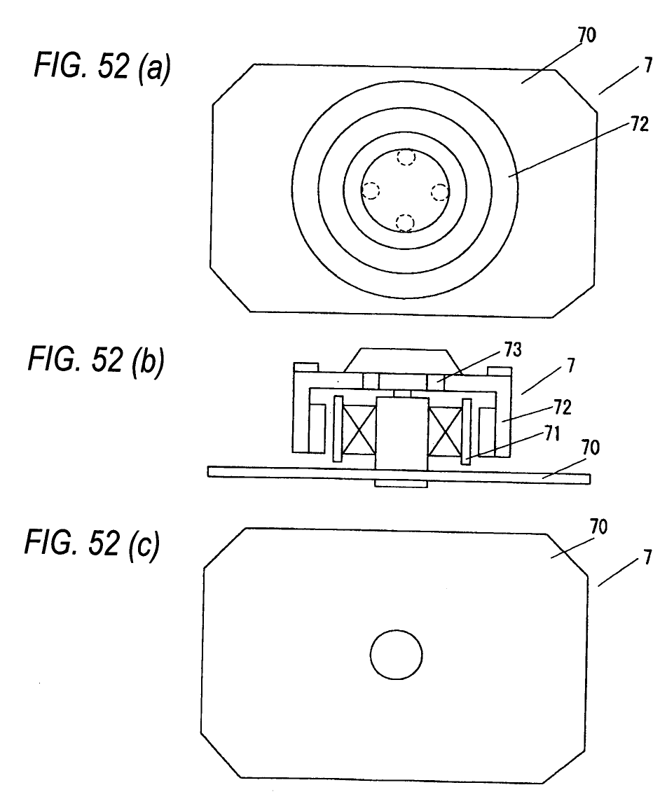

Meanwhile, in the optical disk apparatus in this embodiment, as shown in FIG. 52, it is also possible to configure the opening 73 in an area with a diameter D 15 mm or less from a rotation center of the rotor 72, in a similar fashion. At this time, the opening 73 is positioned in an inside of a optical disk 9 holding mechanism of the rotor 72, and thereby, such an effect that the opening 73 goes out of sight from a top surface of the rotor 72, is obtained.

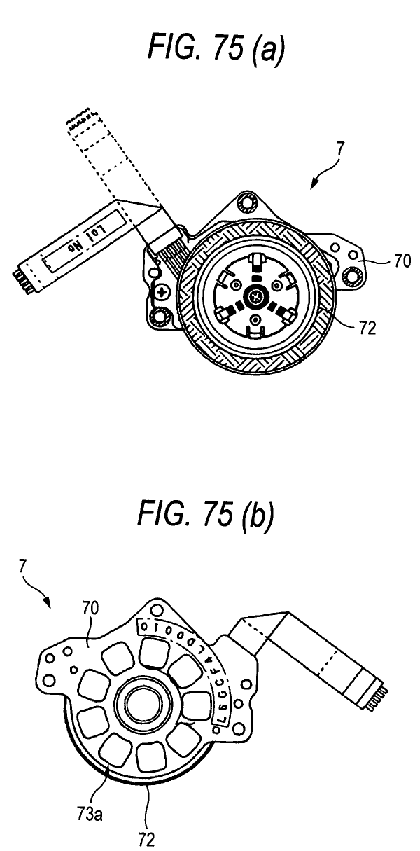

Meanwhile, in the optical disk apparatus of this embodiment, as shown in FIGS. 49, 50, 54, and 55, it is also possible to configure it by disposing a concave portion 74 on the spindle motor frame 70 of the spindle motor 7, which does not rotates together with the optical disk 9, in a similar fashion. It is all right even if this concave portion 74 is one or plural pieces. In addition, as shown in FIG. 75(b), it is also possible to configure it by disposing one or a plurality of openings 73a, in the spindle motor frame 70.

Meanwhile, it is possible to dispose the concave portion which is disposed on the rotor 72, and the concave portion 74 which is disposed on the spindle motor frame 70 by punching out and cutting out after molding, and to dispose a convex portion on a metal die at the time of molding and then, carry out molding, in a similar fashion.

Meanwhile, in the optical disk apparatus of this embodiment, it is also possible to use a lightweight metal material as a material of the rotor 72 and the spindle motor frame 70, in a similar fashion. AS the lightweight metal material, aluminum, aluminum alloy, magnesium alloy, titanium, titanium alloy etc. are desirably used.

Generally, as a material of the rotor 72 and the spindle motor frame 70, a steel product such as SECC is used, but by using a lightweight metal material as a material of the rotor 72 and the spindle motor frame 70, it is possible to realize weight saving of the optical disk apparatus.

As to aluminum and magnesium as a lightweight metal material, relative density as a ratio to steel is ⅓ in case of aluminum, and ¼ in case of magnesium, and in particular, by using a lightweight metal material for the rotor 72 which is movable portion weight, inertia moment of the rotor 72 is reduced, and as a result, electric power consumption of the spindle motor 7 is reduced, and it is possible to suppress rise in heat.

In addition, As to aluminum and magnesium as a lightweight metal material, specific thermal conductivity as a ratio to steel is high, 2 times in case of aluminum, and 1.5 times in case of magnesium. By this means, by using these metal materials particularly for the spindle motor frame 70, it becomes easy to let out heat, which is generated by a coil etc. of the spindle motor 7, from the spindle motor frame 70, and it is possible to suppress rise in heat as the optical disk apparatus.

### Embodiment 6

Next, a joining method of a frame portion and a coating member which were described in the embodiment 1 of the invention will be described, taking further several examples. A configuration of an optical disk apparatus in this embodiment is similar to that of the embodiment 1 of the invention except for a joining method of the frame portion and the coating member.

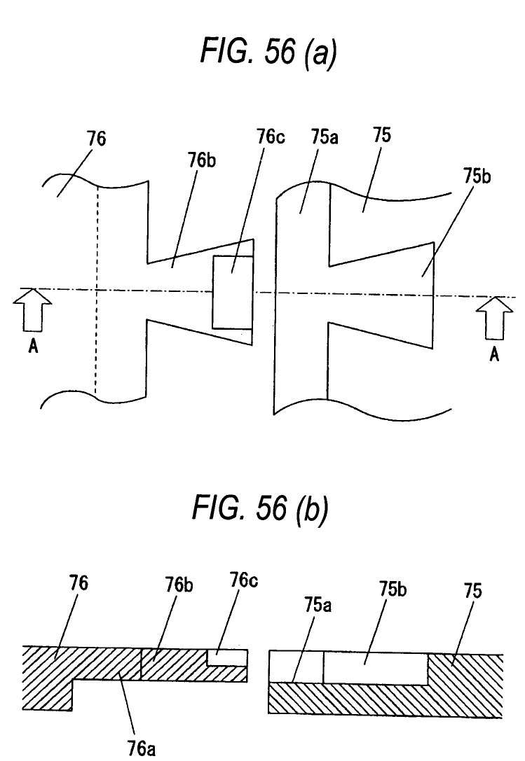

FIGS. 56 through 58 are views which show an optical disk apparatus in an embodiment 6, respectively.

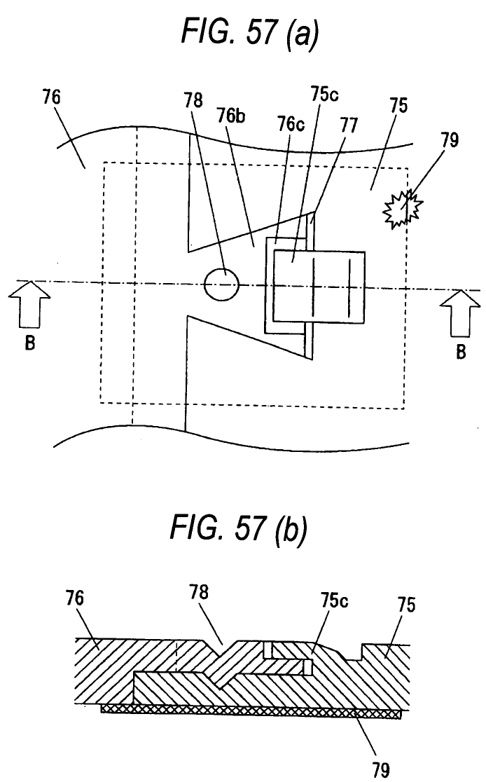

FIG. 56(a) is a plan view of a frame portion and a coating member prior to joining, and FIG. 56(b) is an A-A cross-sectional view of FIG. 56(a), and FIG. 57(a) is a plan view of joining of the frame portion and the coating member, and FIG. 57(b) is a B-B cross-sectional view of FIG. 57(a).

As shown in FIG. 56(a), a plurality of step-dropping down portions 76a are disposed at a peripheral border portion of a coating member 76, or across an entire circumference, and a plurality of protruding portions 76b are disposed in this step-dropping down portion 76a, and this protruding portion 76b becomes, in this embodiment, a protrusion with such a shape that a rood width is small and a width is largely expanded as it goes to an apex. Further, in this embodiment, it is configured in such a manner that a thickness of the step-dropping down portion 76a becomes approximately a half of a thickness of a plate material which configures the coating member 76.

Meanwhile, the step-dropping down portion 75a is disposed at a plurality of places at a peripheral border portion of the protruding portion 76b, or across an entire circumference, and a depressed portion 75b is disposed on this step-dropping down portion 75a, in tune with a plurality of the protruding portions 76b. The depressed portion 75b is configured so as to have a certain clearance with the protruding portion 76b.

In addition, in this embodiment, it is configured in such a manner that a thickness of the step-dropping down portion 75a becomes approximately a half of a thickness of a plate material which configures the frame portion 75.

The protruding portion 76b of the coating member 76 is inserted into the depressed portion 75b of the frame portion 75, and a squeezing process by use of press etc. is applied, and thereby, as shown in FIG. 57(b), a building-up portion 75c, which is pushed out by the frame portion 75, is put in a protrusion-dropping down portion 76c which is disposed on the protruding portion 76b, and the frame portion 75 and the coating member 76 are joined solidly and with a uniform thickness. Meanwhile, at this time, by setting up a dimension of a width on the occasion of disposing the step-dropping down portions 75a and 76a to a predetermined relation, it is possible to dispose a gap 77, and it is possible to alleviate distortion due to a squeezing process by this gap 77. There is no need to dispose this gap 77 depending on a specification etc. It is all right even if a plurality of squeezed portions are disposed for the protruding portion 76b.

Meanwhile, in this embodiment, the depressed portion 75b is disposed on the frame portion 75, and the protruding portion 76b is disposed on the coating member 76, but it is all right even if the protruding portion 76b is disposed on the frame portion 75, and the depressed portion 75b is disposed on the coating member 76.

In addition, as shown in FIG. 57(b), by disposing a depression shape 78 on a portion where the protruding portion 76b and the depressed portion 75b were overlapped, through the use of press molding, joining strength in a board thickness direction (horizontal direction) increases.

Meanwhile, it is all right even if the depression shape 78 is disposed on a portion where the step-dropping down 75a of the frame portion 75 and the step-dropping down portion 76a of the coating member 76 were overlapped.

Further, by pasting a reinforcement sheet 79 on one thin surface of which an adhesive material is painted, on a part of, or at an entire circumference of a joining portion of the frame portion 75 and the coating member 76, joining strength of the frame portion 75 and the coating member 76 increases. In particular, joining strength in a board thickness direction (horizontal direction) increases. A raw material of the sheet is not particularly limited, if it is a material with high tensile strength, such as resin, metal, and cloth, but in the light of strength, workability, pasting working property, cost, etc., a resin sheet is most suitable.

In addition, it is desirable that a thickness of the sheet is 0.1 mm or less as a thickness including an adhesive layer. When a thickness of the sheet becomes more than 0.1 mm, a clearance with the tray disappears, and it becomes an obstacle at the time that a printed board having flexibility is bent.

In this embodiment, the reinforcement sheet 79 is attached to an opposite surface to caulking, but it is all right even if it is attached to a caulking surface.

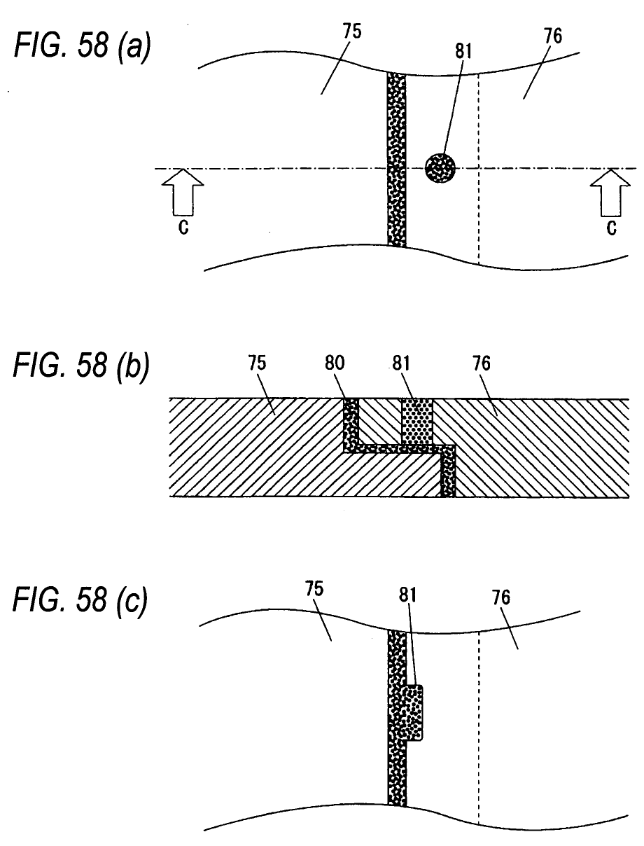

FIG. 58(a) is a plan view after joining of the frame portion 75 and the coating member 76 by use of an adhesive agent, and FIG. 58(b) is a C-C cross-sectional view of FIG. 58(a), and FIG. 58(c) is a plan view after joining of the frame portion 75 and the coating member 76 by use of an adhesive agent.

As shown in FIGS. 58(a) and 58(b), the frame portion 75 and the coating member 76 are joined by interposing an adhesive agent 80 between the step-dropping down portions 75a and 76a, and an adhesive agent confirmation opening 81 is disposed in the coating member 76 side of a joining portion. It is impossible to carry out confirmation of joining quality after adhesion joining is carried out, from an external appearance, and therefore, destructive inspection is commonly carried out. By disposing the adhesive agent confirmation opening 81, it becomes possible to directly check with eyes, forgetting to paint an adhesive agent in an adhesion process, adhesion failure such as lack of an amount of an adhesive agent to be painted, a painting property of an adhesive agent 80, from the adhesive agent confirmation opening 81, and it is possible to improve reliability of joining quality.

Further, in case that an UV cure adhesive agent is used as the adhesive agent 80, it becomes possible to facilitate curing of the adhesive agent 80 from the adhesive agent confirmation opening 81 portion, and it is possible to shorten curing time, and to improve joining reliability.

In addition, it is all right even if the adhesive agent confirmation opening 81 is of a partially cut-out shape as shown in FIG. 58(c).

In this embodiment, the adhesive agent confirmation opening 81 is disposed on the coating member 76 side, but may be disposed on the frame portion 75 side.

### Embodiment 7

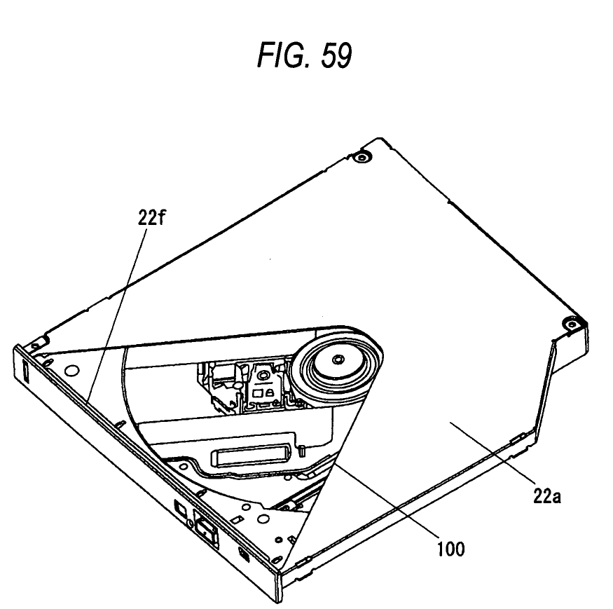

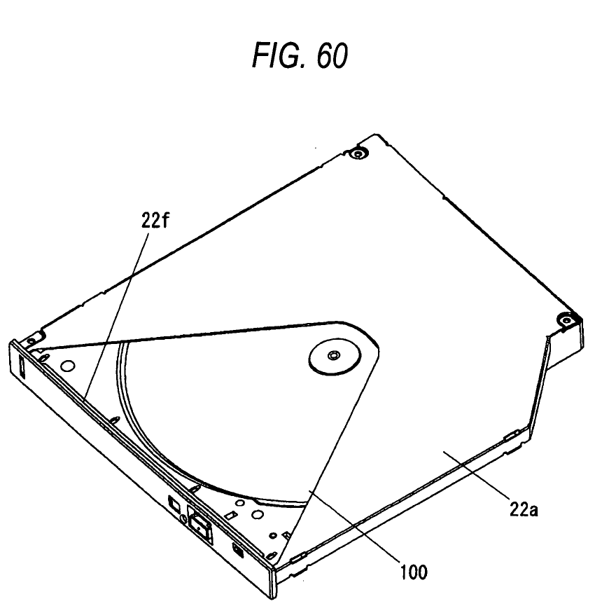

FIGS. 59 through 62 are views which show an optical disk apparatus in an embodiment 7 of the invention, respectively. Meanwhile, the same things as reference numerals and signs shown in FIGS. 76 through 83 are configured by similar shapes, configurations, materials.

In FIGS. 59 through 82, 22 designates a cover, and the cover 22 is configured by joining an upper cover 22a and a lower cover 22b through the use of at least one of joining means such as screws, an adhesive agent and a locking member. The cover 22 has an aperture 22f, and is configured in a pouch shape. In such a state that the tray 2 is put in the cover 22, it becomes such a configuration that the aperture 22f is covered by a bezel 3. In addition, at least the upper cover 22a (as a matter of course, including a case of both of the upper cover 22a and the lower cover 22b) out of the cover 22 is formed by a plate material or a thin plate material which includes a lightweight metal material, and as the lightweight metal material, aluminum, aluminum alloy, magnesium alloy, titanium, titanium alloy etc. are suitably used, and by processing a plate material which is configured by at least one of those materials, the upper cover 22a is configured. In addition, in this embodiment, particularly in consideration of a cost phase and a characteristic phase, aluminum or aluminum alloy is used. In addition, as another embodiment, it is all right even if a multilayer structure is formed by combining plate materials which were configured by the above-described lightweight metal material, each other. For example, it is all right even if the upper cover 22a is configured by combining an aluminum thin plate and an aluminum alloy thin plate, and it is all right even if it is configured by laminating a plurality of an aluminum thin plate and a thin plate which consists primarily of another metal material. In addition, it is all right to use such a compound lightweight plate that a thin plate, which is configured by nickel and nickel alloy, is pasted on both side surfaces of a resin sheet and a resin plate. In addition, it is desirable that at least a thickness of the upper cover 22a is set to 0.15 mm˜0.5 mm, and in case that it is thinner than 0.15 mm, mechanical strength is lowered very much, and there is such a possibility that a trouble occurs, and when it is made thicker than 0.5 mm, it becomes difficult to carry out weight waving.

As shown in FIGS. 59, 60 and 62, in an optical disk apparatus in this embodiment, a V-letter shaped cutout portion 100 is disposed in such a direction that the tray 2 is inserted, at an end portion of a surface which directly faces a rear surface of a reading surface of the optical disk 9 on the aperture 22f side of the cover 22, i.e., at an end portion of the upper cover 22a in a pullout direction of the tray 2. In other words, in such a state that the tray 2 is put in the cover 22, the cutout portion 100 is to be disposed on a part of the upper cover 22a which faces the optical disk 9 which is held by the spindle motor 7 of the tray 2. By this means, it is possible to considerably reduce displacement of the upper cover 22a due to a negative pressure which is generated by such a matter that the optical disk 9 rotates, and it becomes possible to realize considerable weight saving of the upper cover 22a. Meanwhile, it is possible to dispose the cutout portion 100 by a press work, a cutting work, a shearing work, a forge work etc.

Here, by taking away all the upper cover 22a, it is conceivable that much further weight saving is realized, but it is clear that stiffness is low only by the lower cover 22b, and there is such fear that deformation etc. are generated on the occasion of handling of the optical disk apparatus, and when it is tried to improve strength only by the lower cover 22b, it results in such a thing that weight increases more. A box shape is formed by the upper cover 22a and the lower cover 22b, and thereby, stiffness is secured.

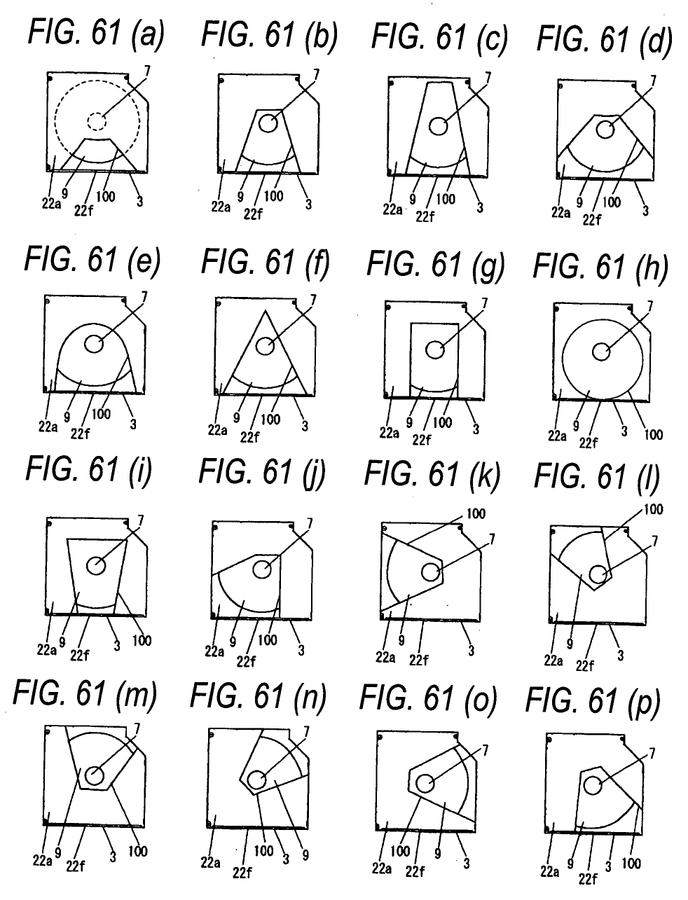

Meanwhile, the cutout portion 100 can be carried out by various configurations, and it is all right even if it is the cutout portion 100 with a shallow cutout by which the spindle motor 7 of the tray 2 does not come out from the upper cover 22a, on the occasion that the tray is loaded on the cover 22, as shown in FIG. 61(a), and even if it is the cutout portion 100 by which the spindle motor 7 comes out from the upper cover 22a, as shown in FIGS. 61(b) through 61(p). In particular, it is also possible to dispose the cutout portion 100 with a deep cutout as shown in FIG. 61(c). In addition, it is possible to carry out a shape of the cutout portion 100 by use of a semicircular shape shown in FIG. 61(e), a V-letter shape shown in FIG. 61(f), a square shape shown in FIG. 61(g), such a shape that a part of a nearly circular shape is cut out as shown in FIG. 61(h), a slot wedge shape shown in FIG. 61(i), and as others, a polygonal shape, a nearly elliptical shape, and various shapes by combining these. In addition, it is possible to dispose the cutout portion 100 in various directions as shown in FIGS. 61(a) through 61(p), in a similar fashion, but upon considering that the tray 2 is pulled out from and inserted into the cover 22, as shown in FIGS. 61(b) through 61(p), FIG. 61(p) among these, it is desirable that a concave shape is realized in such a direction that the tray 2 is inserted, from the aperture 22f side which is covered by the bezel 3, and the spindle motor 7 of the tray 2 which is in such a sate that it is mounted on the cover 22 comes out from the upper cover 22a. Further, among these, as shown in FIGS. 61(b) through 61(f), it is desirable to be configured in such a manner that a width of a cutout is narrowed in such a direction that the tray 2 is inserted from the aperture 22f side. By this configuration, an optical disk apparatus with more lightweight and high stiffness is obtained.

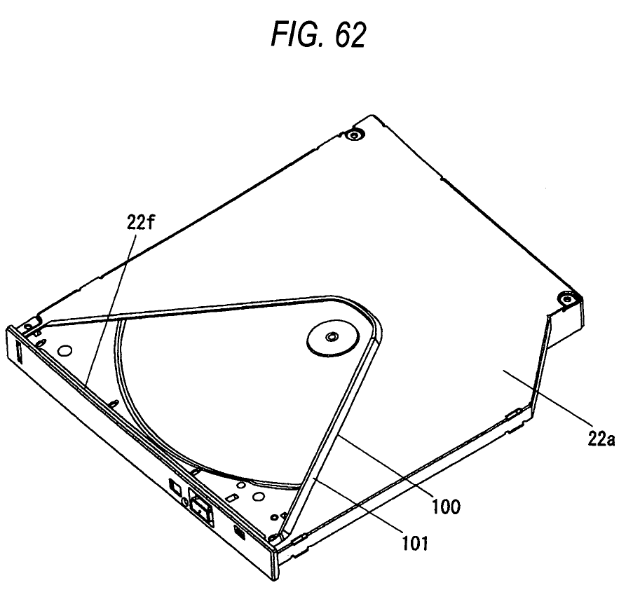

Further, as shown in FIG. 62, it is all right even if an inclined portion 101 is disposed at an end portion of a concave shaped cutout portion 100 of the upper cover 22a. By this configuration, on the occasion of a tray, which is pulled out, is pushed into a housing, it becomes difficult for the optical disk 9 and the spindle motor 7 to get stuck on the upper cover 22a, and the tray can be put in the housing smoothly.

### Embodiment 8

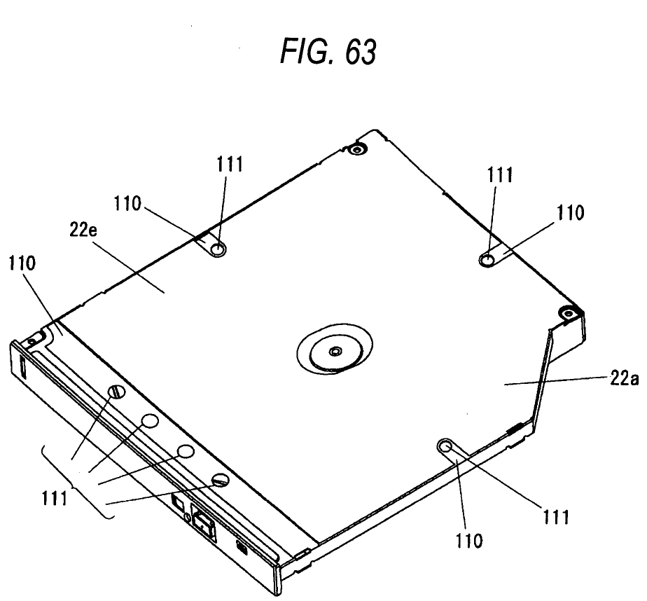

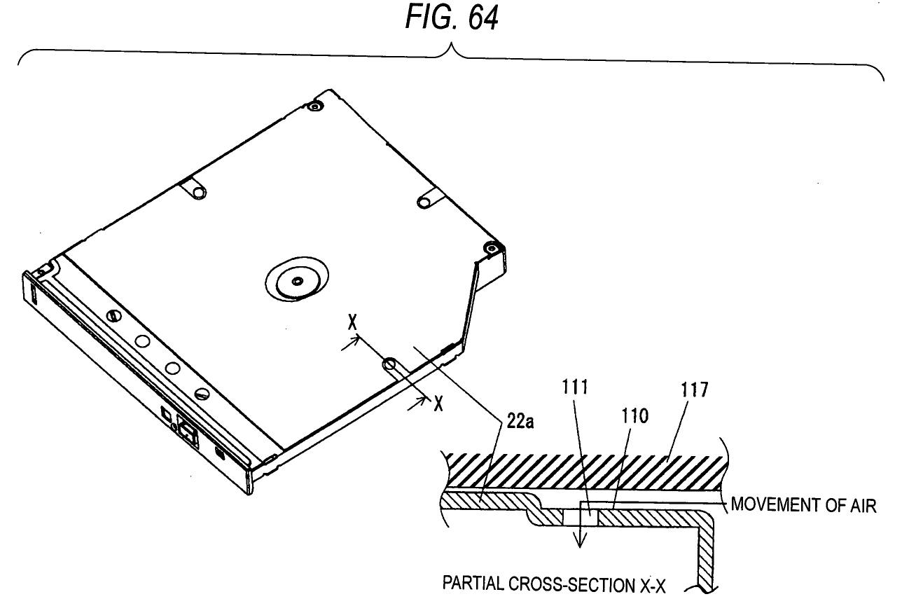

FIGS. 63 and 64 are perspective views which show an optical disk apparatus in an embodiment 8 of the invention. Meanwhile, the same things as reference numerals and signs shown in FIGS. 76 through 83 are configured by similar shapes, configurations, materials.

In FIGS. 63 and 64, 22 designates a cover, and the cover 22 is configured by joining an upper cover 22a and a lower cover 22b through the use of at least one of joining means such as screws, an adhesive agent and a locking member. The cover 22 has an aperture 22f, and is configured in a pouch shape. In such a state that the tray 2 is put in the cover 22, it becomes such a configuration that the aperture 22f is covered by a bezel 3. In addition, at least the upper cover 22a (as a matter of course, including a case of both of the upper cover 22a and the lower cover 22b) out of the cover 22 is formed by a plate material or a thin plate material which includes a lightweight metal material, and as the lightweight metal material, aluminum, aluminum alloy, magnesium alloy, titanium, titanium alloy etc. are suitably used, and by processing a plate material which is configured by at least one of those materials, the upper cover 22a is configured. In addition, in this embodiment, particularly in consideration of a cost phase and a characteristic phase, aluminum or aluminum alloy is used. In addition, as another embodiment, it is all right even if a multilayer structure is formed by combining plate materials which were configured by the above-described lightweight metal material, each other. For example, it is all right even if the upper cover 22a is configured by combining an aluminum thin plate and an aluminum alloy thin plate, and it is all right even if it is configured by laminating a plurality of an aluminum thin plate and a thin plate which consists primarily of another metal material. In addition, it is all right to use such a compound lightweight plate that a thin plate, which is configured by nickel and nickel alloy, is pasted on both side surfaces of a resin sheet and a resin plate. In addition, it is desirable that at least a thickness of the upper cover 22a is set to 0.15 mm˜0.5 mm, and in case that it is thinner than 0.15 mm, mechanical strength is lowered very much, and there is such a possibility that a trouble occurs, and when it is made thicker than 0.5 mm, it becomes difficult to carry out weight waving.

Here, the optical disk apparatus is attached in an inside of a stationary type electronic device such as a personal computer, and a portable type electronic device such as a notebook personal computer, a portable type information terminal device, and a portable type video device, but in case of a portable type electronic device such as a notebook personal computer, in order to realize miniaturization and a thin type, there are many cases in which a housing of another device is disposed without disposing a space above the optical disk apparatus of the invention. In this case, in case that only a through-hole is disposed in the upper cover 22a, for the purpose of reducing a negative pressure force, it becomes difficult to carry out movement of air in the through-hole, and it becomes difficult for the upper cover 22a to be deformed, by a negative pressure which is generated by high speed rotation of the optical disk 9.

In order to solve this, the optical disk apparatus in this embodiment is such a thing that, as shown in FIGS. 63 and 64 (partial cross-sectional view of FIG. 63), a concave shaped step portion 110 (referred to as a concave portion) is disposed on a rear surface of a surface which directly faces a rear surface of a reading surface of the optical disk 9, i.e., an upper surface of the cover 22, a flat surface portion 112 of the upper cover 22a in this embodiment, and a through-hole 111 is disposed in the concave shaped step portion 110. These step portion 110 and through-hole 111 are suitably disposed in the vicinity of particular, an outer circumference portion of an optical disk. By this configuration, even in case that a housing 117 of another device is allocated adjacently to the upper cover 22a, it is possible to move air through the concave shaped step portion 110, in order to reduce a negative pressure in the cover 22, which is particularly generated by high speed rotation of the optical disk 9, and therefore, it is possible to effectively reduce a depression of the upper cover 22a due to a negative pressure which is generated by such a matter that the optical disk 9 rotates, and it becomes possible to realize considerable weight saving, by thinning the upper cover 22a.

In addition, it is desirable that the through-hole 111 is allocated in a range of a diameter Φ 60 mm through Φ 120 mm, centering on a rotation center of the spindle motor 7. By disposing the through-hole 111 in the above-described range, it is possible to surely realize reduction of a negative pressure force particularly in high speed rotation of the optical disk 9.

In this way, by disposing the through-hole 111 in the concave shaped step portion 110, weight saving of the upper cover 22a is realized, and even if mechanical strength and stiffness are lowered to some extent, it is possible to prevent the upper cover 22a from being depressed to contact the optical disk 9 or contact another member.

Meanwhile, in this embodiment, seven through-holes were disposed like the through-hole 111, but it is all right even if they are less than this, and more than this. That is, a plurality of through-holes are disposed, and it is desirable that they are allocated in a circular shape, preferably at predetermined intervals.

Further, in case of using an apparatus under such a circumstance that there are many dusts outside, there is such a possibility that dusts go into an inside through the through-holes 111 through 40 from an outside. In the suchlike case, it is also possible to make such a configuration that a filter member to cover the through-hole 111 is pasted on the upper cover 22a. As the filter member, a bonded textile, a paper, an expandable sheet, a porous sheet etc. are desirably used.

In addition, the through-hole 111 is made as a circular shaped opening, but it is all right even if it is made in a quadrangle shape, in a triangle shape or a polygon shape of more than a pentagon, or it is also all right even if at least one of through-holes is differentiate from a shape of another through-hole. In this way, it is possible to differentiate a shape of a through-hole, or differentiate an allocation position (distance from a center of the spindle motor 7, etc.) of a through-hole.

### Embodiment 9

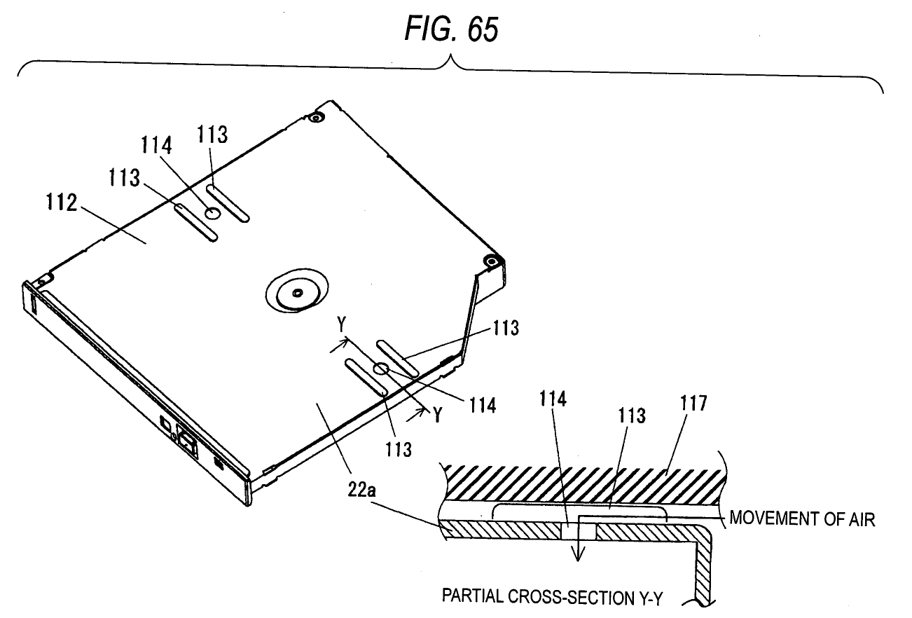

FIG. 65 is a perspective view which shows an optical disk apparatus in an embodiment 9 of the invention. As shown in FIG. 65, the optical disk apparatus in this embodiment is the same as a thing which is described in the embodiment 8 except for a configuration of a step portion and a through-hole. 113 designates a step portion which is disposed in a convex shape (referred to as a convex portion), to a flat surface portion 112, and 114 designates a through-hole which is disposed in the vicinity of the step portion 113. By the suchlike configuration, air can move in the same manner as in the embodiment 8, and therefore, it is possible to obtain similar advantages.

### Embodiment 10

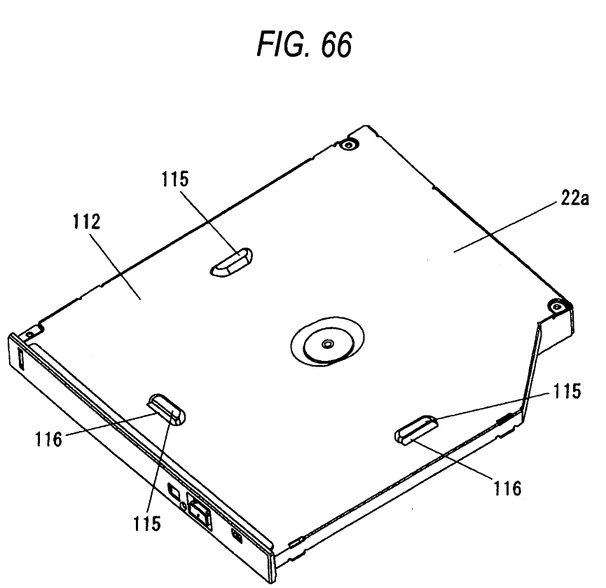

FIG. 66 is a perspective view which shows an optical disk apparatus in an embodiment 10 of the invention. As shown in FIG. 66, the optical disk apparatus in this embodiment is the same as a thing which is described in the embodiment 8 and the embodiment 9 except for a configuration of a step portion and a through-hole. 115 designates a step portion which is disposed in a convex shape, to a flat surface portion 112, and 116 designates a through-hole which is disposed in the vicinity of the step portion 115. Here, the step portion 115 and the through-hole 116 are things which can be formed by a press work in the same manner as in the embodiment 8 and the embodiment 9. By the suchlike configuration, the step portion and the through-hole are configured by identical processing means, and therefore, it is suitable for carrying out mass production.

### Embodiment 11

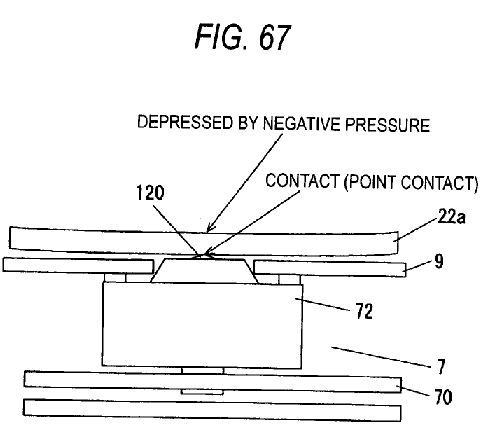

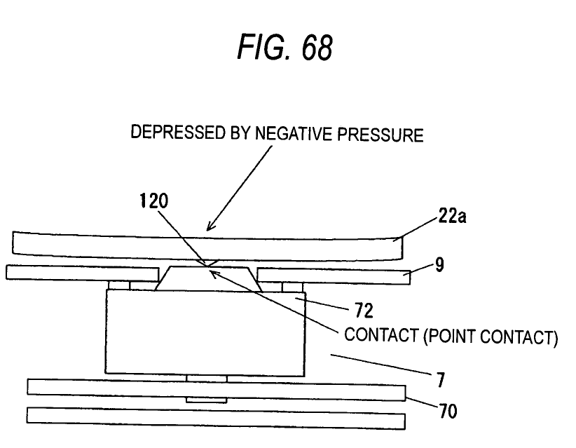

FIGS. 67 and 68 are partial cross-sectional views which shows an optical disk apparatus in an embodiment 11 of the invention, respectively. Meanwhile, the same things as reference numerals and signs shown in FIGS. 76 through 83 are configured by similar shapes, configurations, materials.

In FIG. 67, 120 designates a pointed extremity protrusion which is disposed on the rotor 72 of the spindle motor 7 and which is a point contact member. The pointed extremity protrusion 120 is disposed on the rotor 72 which faces the upper cover 22a, and a pointed extremity thereof exists on a rotation axis of the rotor 72 and gets sharp toward the upper cover 22a. By this configuration, even if the upper cover 22a is considerably displaced on the side of the optical disk 9 by a negative pressure which is generated between the optical disk 9 and the upper cover 22a, it is possible to reduce an effect due to friction, since a contact portion of the upper cover 22a and the spindle motor 7 becomes a point contact. A shaft of the spindle motor 7 is always in contact with a thrust plate in an inside of the spindle motor 7, and weight of the optical disk 9 and a sucking force are applied, on a steady basis. In this embodiment, the pointed extremity protrusion 120 is disposed on the opposite side thereof, and thereby, eve if the upper cover 22a and the spindle motor 7 come into contact with each other, a load due to friction is small, and rotation fluctuation is also few, and in addition, it is possible to prevent loud sound from being generated.

Meanwhile, it is all right even if the pointed extremity protrusion 120 and the rotor 72 are formed integrally, or configured as separate members.

In addition, it is also possible to dispose the pointed extremity protrusion 120 on the upper cover 22a which faces the rotor 72 as shown in FIG. 68, in a similar fashion. In this case, it becomes such a configuration that a pointed extremity of the pointed extremity protrusion 120 is located on a rotation axis of the spindle motor 7 and the rotor 72, and is sharpened toward the rotor 72.

In addition, it is also possible to apply fluorine and good lubricating coating to the pointed extremity protrusion 120 and a portion with which the pointed extremity protrusion comes in contact, in a similar fashion. By this means, surface roughness accuracy is improved, and it is also possible to reduce contact resistance.

Further, in this embodiment, it is explained by use of the pointed extremity protrusion 120, but it is all right if it is a point contact member which the upper cover 22a and the spindle motor 7 come in point contact with each other, in case that the upper cover 22a is considerably displaced on the side of the optical disk 9, and it is also possible to use a member having a nearly spherical surface and a bearing, in a similar fashion.

### Embodiment 12

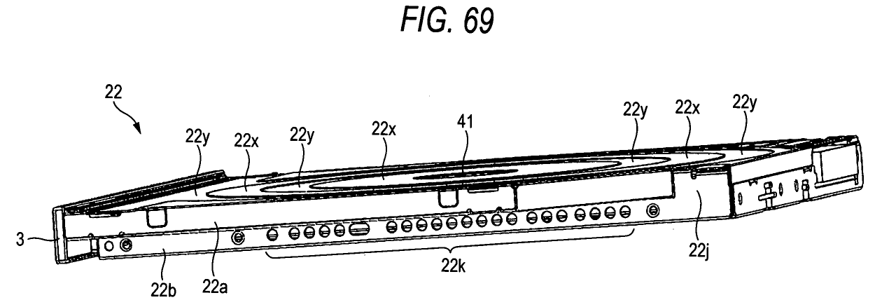

FIGS. 69 through 75 are views which show an optical disk apparatus in this embodiment, respectively, and it becomes a thing which realized weight saving by combining configurations of the embodiment 2, the embodiment 3, the embodiment 4, and the embodiment 5 of the invention. In members shown in FIGS. 69 through 73, there are things which have different shapes etc. from members shown in FIGS. 22 through 55 in some degree, but things with the same reference numerals have nearly identical functions and effects.

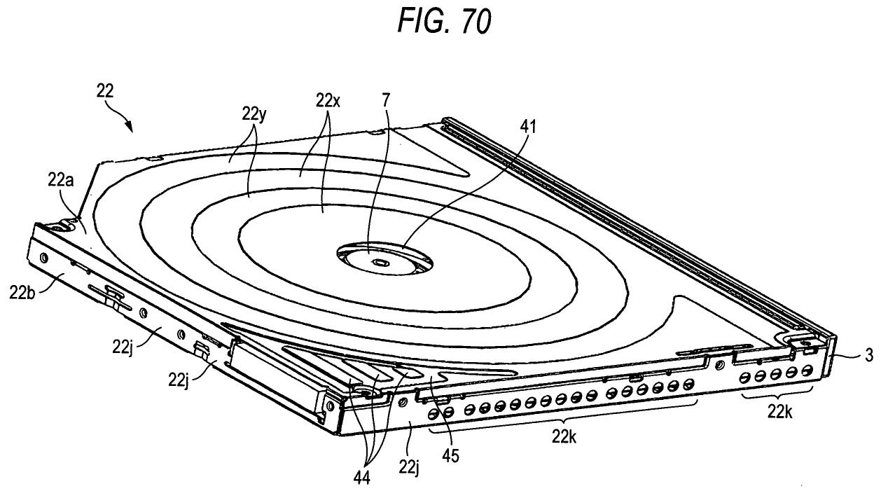

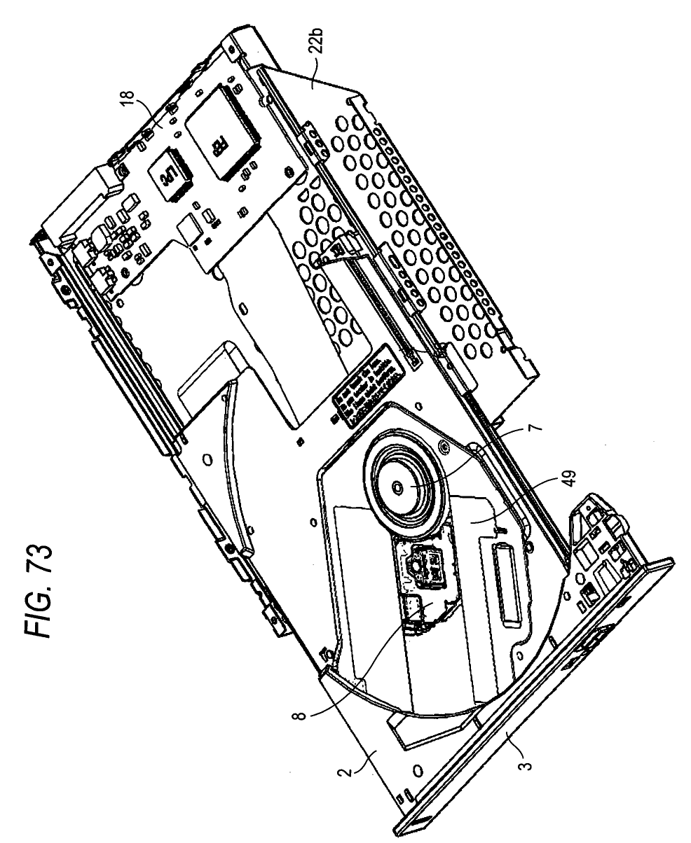

As shown in FIGS. 69 and 70, in the optical disk apparatus in this embodiment, on a surface (in case that an optical disk 9 is loaded on a spindle motor 7 of a tray 2 which is mounted on a cover 22, a surface which faces the optical disk 9) which faces a carriage 8 (shown in FIG. 73) of a cover 22, a convex portion 22x and a concave portion 22y, which are nearly concentric with a center of the cover 22, are disposed two by two, respectively. Here, the center of the cover 22 is a position which faces the spindle motor 7 in the tray 2 (it is surrounded by the cover 22 and it is not shown in the figure), in such a state that it is mounted on the cover, in the cover 22 shown in FIGS. 69 and 70, and in this embodiment, it becomes nearly a center of a through-hole 41 which is disposed in the upper cover 22a. In short, the convex portion 22x and the concave portion 22y are, as shown in FIG. 27(b), disposed on a surface of the upper cover 22a, which faces the carriage 8, concentrically from nearly a center of the through-hole 41, in the order of the concave portion 22y, the convex portion 22x, the concave portion 22y, and the convex portion 22x.

In addition, in this embodiment, as shown in FIGS. 27, 69 and 70, the convex portion 22x on a surface which faces the carriage 8 of the upper cover 22a becomes the concave portion 22y on a rear surface of the surface which faces the carriage 8 of the upper cover 22a, and in addition, the concave portion 22y on the surface which faces the carriage of the upper cover 22a becomes the convex portion 22x on the rear surface of the surface which faces the carriage 8 of the upper cover 22a. In short, taking a look at the optical disk apparatus from an outside, the convex portion 22x and the concave portion 22y are disposed concentrically from nearly a center of the through-hole 41, in the order of the concave portion 22y, the convex portion 22x, the concave portion 22y, and the convex portion 22x.

By the suchlike configuration, it is possible to improve strength of the upper cover 22a, and therefore, it becomes possible to configure it in such a manner that a radial thickness of the upper cover 22a is thinned and lightweight.

In addition, in the optical disk apparatus in this embodiment, as shown in FIG. 70, a concave portion 45 is further disposed outside the concave portion 22y which is disposed on the upper cover 22a, and a convex portion 44 is disposed inside the concave portion 45.

By this means, it is possible to further improve strength of the upper cover 22a, and therefore, it becomes possible to configure it in such a manner that a radial thickness of the upper cover 22a is thinned and lightweight.

In addition, in the optical disk apparatus of this embodiment, as described by use of FIGS. 20 and 21, a dome portion 43 is disposed on the upper cover 22a. In this regard, however, as described in the embodiment 1, it is desirable that a raised height t of the dome portion 43 is 0.2 mm˜1 mm, and in this embodiment, it is of a slight dome shape which is configured by approximately 0.4 mm, and therefore, it is not shown in FIGS. 69 and 70. In addition, in this embodiment, a protruding portion 48 shown in FIG. 21 is not disposed, but by configuring the raised height t of the dome portion 43 with approximately 0.4 mm, it becomes possible to configure the optical disk apparatus as a thin type over maintaining stiffness of the dome portion 43.

In this way, by disposing the dome portion 43 outside the optical disk apparatus in such a manner that it protrudes gradually toward the through-hole 41 on the surface which faces the carriage 8 of the upper cover 22a, there occurs no deformation such as depression of the upper cover 22a easily, since the dome portion 43 is disposed, even if a negative pressure force is generated in an inside of the optical disk apparatus along with rotation of the optical disk 9.

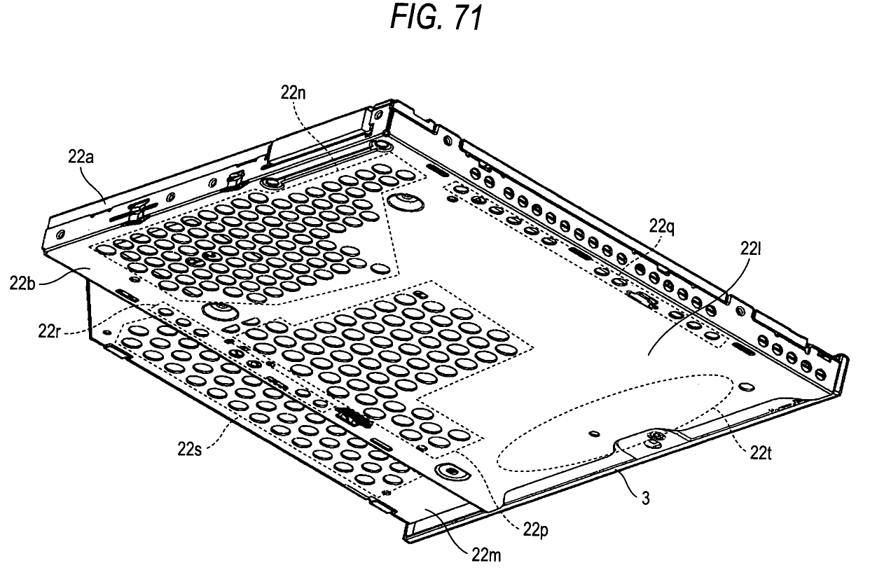

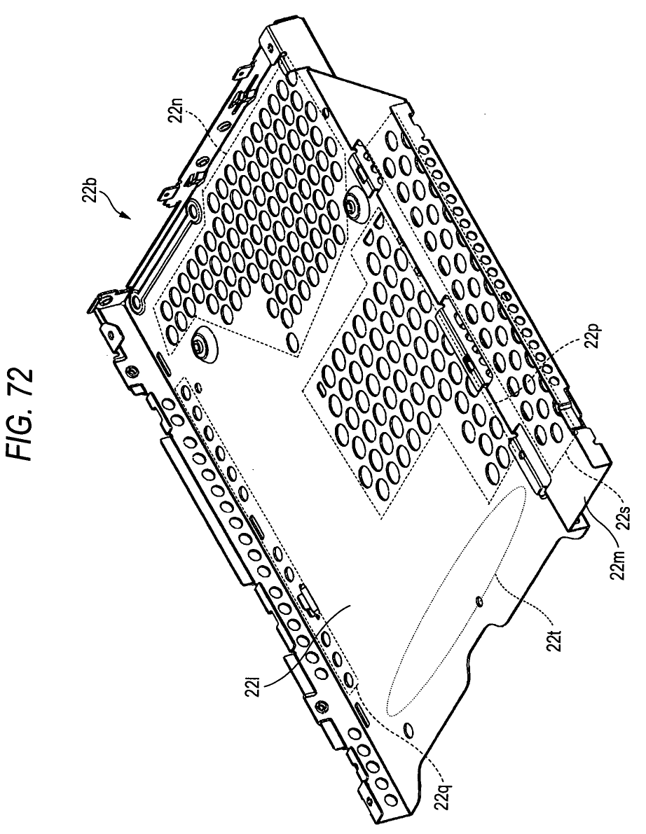

In addition, FIGS. 69 and 70 are such things that a plurality of adjacent holes 22k with nearly the same shape were disposed on a vertical wall portion 22j (a surface which is configured by a surface which is perpendicular to the optical disk 9 loaded on the spindle motor 7) of the lower cover 22b, and FIGS. 71 and 72 are such things that a plurality of adjacent holes 22n, 22p, 22q, 22r, and 22s with the same shape were disposed on flat surface portions 22l, 22m (surfaces which are configured by surfaces which are parallel to the optical disk 9 loaded on the spindle motor 7) of the lower cover 22b. In members shown in FIGS. 69 through 73, there are things which have different shapes etc. from members shown in FIGS. 22 through 55 in some degree, but things with the same reference numerals have nearly identical functions and effects.

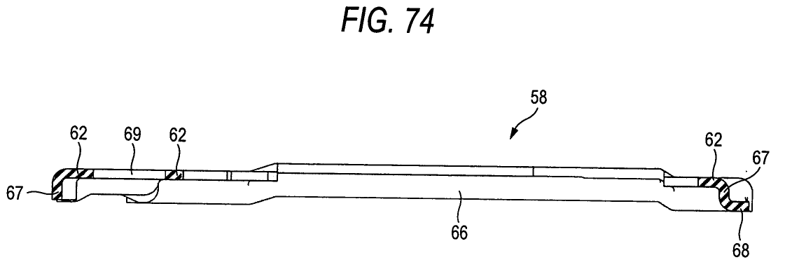

FIG. 74 is a view which shows a pickup frame 58 of a pickup module 49 of the optical disk apparatus of this embodiment, and an A-A cross-sectional view of the pickup frame 58 shown in FIG. 25. The pickup frame 58 of the optical disk apparatus of this embodiment is a thing which is described in the embodiment 2.

FIG. 75 is a view which shows a configuration of a spindle motor 7 in this embodiment, and FIG. 75(a) is a front surface view of the spindle motor 7, taking a look at the spindle motor 7 from a rotor 72 side, and in addition, FIG. 75(b) is a back surface view of the spindle motor 7, taking a look at the spindle motor 7 from a spindle motor frame 70 side. In this embodiment, a plurality of openings 73a are disposed in the spindle motor frame 70 of the spindle motor 7.

As above, focusing attention on such a thing that mechanical strength of each portion becomes a problem when each portion is configured by a relatively lightweight material, so as to realize weight saving of the optical disk apparatus, and furthermore, a configuration of thinning a radial thickness is adopted in some cases, even if weight saving is realized by adopting at least one configuration of at least the above-described (embodiment 1), (embodiment 2), (embodiment 3), (embodiment 4), (embodiment 5), (embodiment 6), (embodiment 7), (embodiment 8), (embodiment 9), (embodiment 10), (embodiment 11), and (embodiment 12), it is possible to suppress lowering of mechanical strength of each portion.

In addition, by making a configuration which satisfies the configurations which were described in the embodiments 1 through 12 simultaneously by combining them, it is possible to realize an optical disk apparatus with weight of 120 g or less (100 g or less).

In addition, by using at least one of at least the upper cover 22a, the lower cover 22b, the pickup module 49, the spindle motor 7, the pickup frame 58, and the pickup module 50 as the above-described configuration, it is possible to realize weight saving of an optical disk apparatus.

The invention can prevent deformation of a pickup cover due to a fixing force by fixing means such as a screw, and thermal deformation which arises from such a matter that materials of a pickup cover and a pickup frame are different and their thermal expansion coefficients are different, and is applicable to an optical disk apparatus etc. which are suitably used for a stationary type electronic device such as a personal computer, and a portable type electronic device such as a notebook personal computer, a portable type information terminal device, and a portable type video device.

This application is based upon and claims the benefit of priority of Japanese Patent Application No 2004-061981 filed on Apr. 3, 2005, Japanese Patent Application No 2004-061982 filed on Apr. 3, 2005, Japanese Patent Application No 2004-061983 filed on Apr. 3, 2005, Japanese Patent Application No 2004-061984 filed on Apr. 3, 2005, Japanese Patent Application No 2004-061985 filed on Apr. 3, 2005, Japanese Patent Application No 2004-140790 filed on Apr. 5, 2011, Japanese Patent Application No 2004-140791 filed on Apr. 5, 2011, Japanese Patent Application No 2004-146279 filed on Apr. 5, 2017, Japanese Patent Application No 2004-147450 filed on Apr. 5, 2018, Japanese Patent Application No 2004-299889 filed on Apr. 10, 2014, Japanese Patent Application No 2004-299890 filed on Apr. 10, 2014, Japanese Patent Application No 2004-333017 filed on Apr. 11, 2017, the contents of which are incorporated herein by references in its entirety.

1. An optical disk apparatus, comprising:
a cover;
a tray, which is disposed in such a manner that it can be inserted into and pulled out from the cover;
a spindle motor, which is disposed on the tray and rotates an optical disk; and
a carriage, which is held on the tray in a movable manner, on which an optical device which carries out at least one of recording and reproduction of information on an optical disk is mounted, and which comes close to and comes free from the spindle motor;
wherein on a surface of the cover which faces the carriage, at least one of a concave portion or a convex portion, which is of a nearly circular shape nearly concentrically with a center of the cover or of a polygonal shape nearly concentrically with a center of the cover, is disposed.

2. The optical disk apparatus according to claim 1, wherein: at least one of a concave portion or a convex portion is disposed outside the convex portion or concave portion which is of a nearly circular shape nearly concentrically with a center of the cover or of a polygonal shape nearly concentrically with a center of the cover.

3. The optical disk apparatus according to claim 1, wherein:
the cover is configured so as to include at least one of aluminum, aluminum alloy, magnesium alloy, titanium, titanium alloy, CFRP (Carbon Fiber Reinforced Plastic), and LCP (Liquid Crystal Polymer).

4. The optical disk apparatus according to claim 1, wherein:
the convex portion of the cover, which is disposed on a surface facing to the carriage, becomes a concave portion at its rear surface, or the concave portion of the cover, which is disposed on a surface facing to the carriage, becomes a convex portion at its rear surface.

5. The optical disk apparatus according to claim 1, wherein:
the concave portion or convex portion is disposed by applying a press work to the cover.

6. The optical disk apparatus according to claim 1, wherein a thickness of the cover is set to 0.15 mm˜0.5 mm.

7. The optical disk apparatus according to claim 1, wherein:
the cover is configured so as to become a pouch shape by combining first and second covers;
the tray is attached to the first cover in a movable manner; and
at least one of the concave portion or convex portion is disposed on the second cover.

8. An optical disk apparatus, comprising:
a cover;
a tray, which is disposed in such a manner that it can be inserted into and pulled out from the cover;
a spindle motor, which is disposed on the tray and rotates an optical disk; and
a carriage, which is held on the tray in a movable manner, on which an optical device which carries out at least one of recording and reproduction of information on an optical disk is mounted, and which comes close to and comes free from the spindle motor;
wherein a dome portion, which is lifted up as it proceeds to a center of the cover, is disposed on the cover.

9. The optical disk apparatus according to claim 8, wherein:
a protruded portion is disposed between the dome portion and the cover outer circumference portion.

10. The optical disk apparatus according to claim-8, wherein:
concave and convex shaped ribs is disposed outside the dome portion.

11. An optical disk apparatus, comprising:
a cover;
a tray, which is disposed in such a manner that it can be inserted into and pulled out from the cover;
a spindle motor, which is disposed on the tray and rotates an optical disk; and
a carriage, which is held on the tray in a movable manner, on which an optical device which carries out at least one of recording and reproduction of information on an optical disk is mounted, and which comes close to and comes free from the spindle motor;
wherein a plurality of holes with at least one kind same shape are disposed adjacently with each other.

12. The optical disk apparatus according to claim 11, wherein:
the cover is configured so as to include at least one of aluminum, aluminum alloy, magnesium alloy, titanium, and titanium alloy.

13. The optical disk apparatus according to claim 11, wherein:
a maximum aperture dimension of the hole, which is disposed in the cover, is smaller than 10 mm.

14. The optical disk apparatus according to claim 11, wherein:
an aperture ratio of the hole, which is disposed in the cover, is 80% or less at the aperture portion of the hole.

15. The optical disk apparatus according to claim 11, wherein:
the hole, which is disposed in the cover, has a step portion at an end portion of the hole.

16. The optical disk apparatus according to claim 11, wherein:
a control substrate is fixed to the cover, and the hole is disposed on a surface which faces the control substrate.

17. The optical disk apparatus according to claim 11, wherein:
the hole is disposed on a surface of the cover, which is nearly perpendicular to an optical disk.

18. The optical disk apparatus according to claim 11, wherein:
a thickness of the cover is set to 0.15 mm˜0.5 mm.

19. The optical disk apparatus according to claim 11, wherein:
the cover is configured so as to become a pouch shape by combining first and second covers, and the tray is attached to the first cover in a movable manner, and the hole is disposed in the second cover.

20. A pickup module, comprising:
a frame;
a spindle motor, which is fixed to the frame; and
a carriage, which is held on the frame in a movable manner, on which an optical device which carries out at least one of recording and reproduction of information on an optical disk is mounted, and which comes close to and comes free from the spindle motor;
wherein the frame is equipped with an internal portion which is disposed on an inside of the frame;
a standing-disposed portion which is disposed integrally with the inner portion;
an outer portion which is disposed integrally with the standing-disposed portion and is disposed on an outside of the frame; and
a fixing portion which is disposed on the outer portion and becomes an attaching portion to another member.

21. The pickup module according to claim 20, wherein:
the frame is configured so as to include at least one of aluminum, aluminum alloy, magnesium alloy, titanium, and titanium alloy.

22. The pickup module according to claim 20, further comprising:
protruded portions which are formed at both sides of the fixing portion by a squeezing work.

23. An optical disk apparatus, comprising:
a cover;
a tray, which is disposed in such a manner that it can be inserted into and pulled out from the cover; and
the pickup module according to claim 20, which is fixed to the tray.

24. An optical disk apparatus, comprising:
a cover,
a tray, which is disposed in such a manner that it can be inserted into and pulled out from the cover;
a spindle motor, which is disposed on the tray and rotates an optical disk, and
a carriage, which is held on the tray in a movable manner, on which an optical device which carries out at least one of recording and reproduction of information on an optical disk is mounted, and which comes close to and comes free from the spindle motor;
wherein an opening, or a concave portion is disposed in a part of a spindle motor frame which is provided on the spindle motor.

25. The optical disk apparatus according to claim 24, wherein a plurality of the openings, or concave portions are disposed.

26. The optical disk apparatus according to claim 24, wherein:
a lightweight metal material is used for the spindle motor frame.

27. The optical disk apparatus according to claim 24,
wherein the opening, or concave portion is disposed in a part of a rotor which is provided on the spindle motor.

28. The optical disk apparatus according to claim 27, wherein:
a plurality of the openings, or concave portions are disposed.

29. The optical disk apparatus according to claim 27, wherei the opening, or concave portion is disposed on a surface which faces an optical disk.

30. The optical disk apparatus according to claim 27, wherein the opening, or concave portion is disposed in an area within a diameter φ 15 mm from a rotation center of the rotor.

31. The optical disk apparatus according to claim 27, wherein:
the opening, or concave portion is disposed on a side surface of the rotor.

32. The optical disk apparatus according to claim 27, wherein:
the opening, or concave portion is disposed on a portion of the rotor, which holds an optical disk.

33. The optical disk apparatus according to claim 27, wherein a lightweight metal material is used for the rotor.
